(19) United States
(12) Patent Application Publication
(10) Pub. No.: US 2002/0032558 A1
(43) Pub. Date: Mar. 14, 2002

(54) Method and apparatus for enhancing the performance of a pipelined data processor

(76) Inventors: Paul Strong, Chelmsford (GB); Henry A. Davis, Santa Cruz, CA (US)

Correspondence Address: Robert F. Gazdzinski, Attorney of Record, 3914 Murphy Canyon Road, Suite A232, San Diego, CA, 92123, US

(21) Appl. No.: 09/802,046

(22) Filed: Mar. 8, 2001

Related U.S. Application Data
(60) Provisional application No. 60/188,428, filed on Mar. 10, 2000.
(60) Provisional application No. 60/189,634, filed on Mar. 14, 2000.
(60) Provisional application No. 60/188,942, filed on Mar. 13, 2000.
(60) Provisional application No. 60/189,709, filed on Mar. 15, 2000.

(51) Int. Cl. G06F 9/45

(52) U.S. Cl. 703/22

(57) ABSTRACT

A method and apparatus for enhancing the performance of a multi-stage pipeline in a digital processor. In one aspect, the stalling of multi-word (e.g. long immediate data) instructions on the word boundary is prevented by defining oversized or “atomic” instructions within the instruction set, thereby also preventing incomplete data fetch operations. In another aspect, the invention comprises delayed decode of breakpoint instructions within the core so as to remove critical path restrictions in the pipeline. In yet another aspect, the invention comprises a multi-function register disposed in the pipeline logic, the register including a bypass mode adapted to selectively bypass or “shortcut” subsequent logic, and return the result of a multi-cycle operation directly to a subsequent instruction requiring the result. Improved data cache integration and operation techniques, and apparatus for synthesizing logic implementing the aforementioned methodology are also disclosed.

### BACKGROUND OF THE INVENTION

1. Field of the Invention

The present invention relates to the field of digital data processor design, specifically to the control and operation of the instruction pipeline of the processor and structures associated therewith.

2. Description of Related Technology

RISC (or reduced instruction set computer) processors are well known in the computing arts. RISC processors generally have the fundamental characteristic of utilizing a substantially reduced instruction set as compared to non-RISC (commonly known as “CISC”) processors. Typically, RISC processor machine instructions are not all micro-coded, but rather may be executed immediately without decoding, thereby affording significant economies in terms of processing speed. This “streamlined” instruction handling capability furthermore allows greater simplicity in the design of the processor (as compared to non-RISC devices), thereby allowing smaller silicon and reduced cost of fabrication.

RISC processors are also typically characterized by (i) load/store memory architecture (i.e., only the load and store instructions have access to memory; other instructions operate via internal registers within the processor); (ii) unity of processor and compiler; and (iii) pipelining.

Despite their many advantages, RISC processors may be prone to significant delays or stalls within their pipelines. These delays stem from a variety of causes, including the design and operation of the instruction set of the processor (e.g., the use of multi-word and/or “breakpoint” instructions within the processor's instruction set), the use of non-optimized bypass logic for operand routing during the execution of certain types of instructions, and the non-optimized integration (or lack of integration) of the data cache within the pipeline. Furthermore, lack of parallelism in the operation of the pipeline can result in critical path delays which reduce performance. These aspects are described below in greater detail.

Multi-word Instructions

Many RISC processors offer programmers the opportunity to use instructions that span multiple words. Some multi-word instructions permit a greater number of operands and addressing modes while others enable a wider range of immediate data values. For multi-word immediate data, the pipelined execution of instructions has some inherent limitations including, inter alia, the potential for an instruction containing long immediate data to be impacted by a pipeline stall before the long immediate data has been completely fetched from memory. This stalling of an incompletely fetched piece of data has several ramifications, one of which is that the otherwise executable instruction may be stalled before it is necessary to do so. This leads to increased execution time and overhead within the processor. Stalling of the processor due to unavailabiliy of data causes the processor to insert one or more additional clock cycles. During these clock cycles the processor can not advance additional instruction execution as a general rule. This is because the incomplete data can be considered to be a blocking function. This blocking action is to cause execution to remain pending until the data becomes available. For example, consider a simple add instruction that adds two quanities and places the result in a third location. Providing that both pieces of data are available when needed, the execution completes in the normal number of cycles. Now consider the case in which one of the pieces of data is not available. In this case completion of the add instruction must stop until the data becomes available. The consequence of this stalling action is to possibly delay the completion by more than the minimum necessary time.

Breakpoint Instructions

One of the useful RISC instructions is the “breakpoint” instruction. Chiefly for use during the design and implementation phases of the processor (e.g., software/hardware integration and software debug), the breakpoint instruction causes the CPU to stop execution of any further instructions without some type of direct intervention, typically at the request of an operator. Once the breakpoint instruction has been executed by the pipeline, the CPU stops further processing until it receives some external signal such as an interrupt which signals to the CPU that execution should resume. Breakpoint instructions typically replace or displace some other executable instruction which is subsequently executed upon resumption of the normal execution state of the CPU.

Execution time is critical for many applications, hence minimizing so-called critical paths in the decode phase of a multi-stage pipelined CPU is an important consideration. Since the breakpoint instruction is a performance critical instruction during normal execution, the prior art practice has been to perform the breakpoint instruction decode and execution in the first pipeline stage of the typical four-stage pipeline (i.e., fetch, decode, execution, and write-back stages). FIG. 1 illustrates a typical prior art breakpoint instruction decode architecture. As shown in FIG. 1, the prior art stage 1 configuration 100 comprises the stage 1 latch 102, instruction cache 104, instruction decode logic 106, instruction request address selection logic 108, the latter providing input to the stage 2 latches 110. The current program counter (pc) address value is input 112 back to the stage 1 latch 102 for subsequent instruction fetch. Instruction decode, including decode of any breakpoint instructions, occurs within the instruction decode logic 106. However, such decoding in the first stage places unnecessary demands on the speed path of ordinary instruction handling. Ordinary instructions are decoded in stage 2 (decode) of the pipeline. This stage one decode of the breakpoint instruction places minimum decode requirements on the first stage that are longer than would otherwise be required without having breakpoint instruction decode occur in the first stage. This result is due largely to the fact that the breakpoint instruction requires time to setup and disable a variety of functional blocks. For example, in the ARC™ extensible RISC processor architecture manufactured by the Assignee hereof, functional blocks may include optional mulitply-accumlate hardware, Viterbi acceleration units, and other specific hardware accelerators in addition to standard functional blocks such as an arithmetic-logic unit, address generator units, interrupt processors and peripheral devices. Setup for each of these units will depend on the exact nature of the unit. For example, a single cycle unit for which state information is not required for the unit to function, may require no specialized set up. By contrast, an operation that requires mulitple pipeline stages to complete will require assertion of signals within the pipeline to ensure that and transitory results are safely stored in appropriate registers. Where as other instructions are simply fetched in stage 1, the breakpoint instruction requires control signals to be generated to most elements of the core. This results in longer netlists and hence greater delays.

Bypass logic

Bypass logic is sometimes used in RISC processors (such as the aforementioned ARC core) to provide additional flexibility for routing operands to a variety of input options. For example, as illustrated in FIG. 2, outputs of various functional units (such as the first and second execute stage result selection logic) are routed back to the input of another functional unit; e.g., decode stage bypass operand selection logic. This bypass arrangement eliminates a number of load and store operations, reduces the number of temporary variable locations needed during execution, and stages data in the proper location for iterative operations. Such bypass arrangements permit software to exploit the nature of pipelined instruction execution. Using the prior art bypass circuitry of FIG. 2, a program can be configured to perform pipelined iterative algorithms. One such algorithm is the sum-of-products for a finite series. Since the processor performs scalar operations, each stage of the summation is achieved by a single multiply followed by a single addition of the result to a sum. This principal is illustrated by the following operation:

Sum=0

For I=1 to n do

Sum=sum+(a(I)*b(I));

In a commonly used prior art CPU scheme, the value of Sum is stored in a dedicated general purpose register or in a memory location. Each iteration requires a memory fetch or register access operation to calculate the next summation in the series. Since the CPU can only perform a limited number of memory or register accesses per cycle, this form may execute relatively slowly in comparison to a single cycle ideal for the sum-of-products operation (i.e., where the sum-of-products is calculated entirely within a single instruction cycle), or even in comparison to a non-single cycle operation where memory fetches or register accesses are not required in each iteration of the operation.

Data Cache Integration

For a number of instruction types within the instruction set of the typical RISC processor, there in no requirement for or need to stall the pipeline. However, some other instruction types will require a stall to occur. The ordinary prior art method for integrating a data cache with a processor core relies on a technique that assumes that the worst case evaluation for stalls must be applied to even those cases where the most extreme case specifically does not apply. This “worst case” approach leads to an increased number of pipeline stalls (and/or increased duration for each stall) as well as increased overhead, thereby resulting ultimately in increased execution time and reduced pipeline speed.

FIG. 3 is a logical block diagram illustrating typical prior art data cache integration. It assumes the cache request originates directly from the pipeline rather than the load store queue. Note the presence of the bypass operand selection logic 302, the control logic hazard detection logic 304, and the multi-level latch control logic 306 structures within the second (E2) execution stage.

FIG. 3a illustrates the operation of the typical prior art data cache structure of FIG. 3 in the context of an exemplary load (Ld), move (Mov), and add (Add) instruction sequence. The exemplary instruction sequence is as follows:

| | |
|---|---|
| Ld r0,[r1,4] | |
| Mov r5,r4 | ;independent of the load |
| Add r8,r0,r9 | ;dependent on first load |

First, in step 350, the Load (Ld) is requested. The Mov is then requested in step 352. In step 354, the Add is requested. The Ld operation begins in step 356. Next, the Mov operation begins in step 358. The cache misses. Accordingly, the Add is then prevented from moving.

In step 360, the Mov continues to flow down the pipeline. In step 362, the Add moves down the pipeline in response to the Load operation completing. The pipeline then flows with no stalls (steps 364, 366, and 368).

Note that in the foregoing example, the Add instruction is prevented from moving from the decode stage of the pipeline to the first execute stage (E1) for several cycles. This negatively impacts pipeline performance by slowing the execution of the Add instruction.

Pipeline Parallelism

Often in prior art processor systems, the instruction cache pipeline integration is far from optimal. This results in many cases from the core effectively making the cache pipeline stages 0 and 1 dependent on each other. This can be seen diagrammatically in FIG. 4, wherein the pipeline control 402, instruction decode 404, nextpc selection 406, and instruction cache address selection 408, are disposed in the instruction fetch stage 412 of the pipeline. The critical path of this non-optimized pipeline 400 allows the control path of the processor to be influenced by a slow signal/data path. Accordingly the slow data path must be removed if the performance of the core is to be improved. For example, in most core build instances, the prior art approach means the instruction fetch pipeline stage has an unequal duration to the other pipeline stages, and in general becomes the limiting factor in processor performance since it limits the minimum clock period.

FIG. 4a is a block diagram of components and instruction flow within the non-optimized processor design of FIG. 4. As illustrated in FIG. 4a, the slow signal/data path influences the control path for the pipeline 400.

Based on the foregoing, there is a need for an improved methods and apparatus for enhancing pipeline operation, including reducing stalls and delays in CPU execution. Ideally, several aspects of pipeline operation would be optimized by such improved method and apparatus, including (i) handling of multi-word instructions and immediate data, such as in the calculation of such scalar quantities with a reduced number of memory fetches or register accesses; (ii) use of breakpoint instructions; (iii) bypass logic arrangement, (iv) data cache operation/integration, and (v) increased parallelism within the pipeline. Additionally, such improved apparatus and method would be readily adapted to existing processor designs and architectures, thereby minimizing the work necessary to integrate such functionality, as well as the impact on the processor design as a whole.

### Summary of the Invention

The foregoing needs are satisfied by providing an improved method and apparatus for enhanced performance in a pipelined processor.

In a first aspect of the invention, a method and apparatus for avoiding the stalling of long immediate data instructions, so that processor performance is maximized, is disclosed. The invention results in not enabling the host to halt the core before an instruction with long immediate values in the decode stage of the pipeline has merged, thereby advantageously making the instructions containing long immediate data “non-stallable” on the boundary between the instruction opcode and the immediate data. Consequently the instruction containing long immediate data is treated as if the CPU was wider in word width for that instruction only. The method generally comprises providing a first instruction word; providing a second instruction word; and defining a single large instruction word comprising the first and second instruction words; wherein the single large instruction word is processed as a single instruction within the processor's pipeline, thereby reducing pipeline delays.

In a second aspect of the invention, an improved apparatus for decoding and executing breakpoint instructions, so that processor pipeline performance is maximized, is disclosed. In one exemplary embodiment, the apparatus comprises a pipeline arrangement with instruction decode logic operatively located within the second stage (e.g., decode stage) of the pipeline, thereby facilitating breakpoint instruction decode in the second stage versus the first stage as in prior art systems. Such decode in the second stage removes several critical “blockages” within the pipeline, and enhances execution speed by increasing parallelism therein.

In a third aspect of the invention, an improved method for decoding and executing breakpoint instructions, so that processor pipeline performance is maximized, is disclosed. Generally, the method comprises providing a pipeline having at least first, second, and third stages; providing a breakpoint instruction word, the breakpoint instruction word resulting in a stall of the pipeline when executed; inserting the breakpoint instruction word into the first stage of the pipeline; and delaying decode of the breakpoint instruction word until the second stage of the pipeline. In one exemplary embodiment, the pipeline is a four stage pipeline having fetch, decode, execution, and write-back stages, and decode of the breakpoint instruction is delayed until the decode stage of the processor. Additionally, to support the decoding the breakpoint instruction in the decode stage, the method further comprises changing the program counter (pc) from the current value to a breakpoint pc value.

In a fourth aspect of the invention, an improved method of debugging a processor design is disclosed. The method generally comprises providing a processor hardware design having a multi-stage pipeline; providing an instruction set including at least one breakpoint instruction adapted for use with the processor hardware design; running at least a portion of the instruction set (including the breakpoint instruction) on the processor design during debug; decoding the at least one breakpoint instruction at the second stage of the pipeline; changing the program counter (pc) from the current value to a breakpoint pc value; executing the breakpoint instruction on order to halt processor operation; and debugging the instruction set or hardware/instruction set integration while the processor is halted.

In a fifth aspect of the invention, an apparatus for bypassing various components and registers within a processor so as to maximize pipeline performance is disclosed. In one embodiment, the apparatus comprises an improved logical arrangement employing a special multi-function register having a selectable “bypass mode”; when in bypass mode, the multi-function register is used to retain the result of a multi-cycle scalar operation (e.g., summation in a sum-of-products calculation), and present this result as a value to be selected from by a subsequent instruction. In this fashion, memory accesses to obtain such summation are substantially obviated, and the pipeline accordingly operates at a higher speed due to elimination of the delays associated with the obviated memory accesses.

In a sixth aspect of the invention, a method for bypassing various components and registers within a processor so as to maximize processor performance is disclosed. In one embodiment, the method comprises providing a multi-function register; defining a bypass mode for the register, wherein the register maintains the result of a multi-cycle scalar operation therein during such bypass mode; performing a scalar operation a first time; storing the result of the operation in the register in bypass mode; obtaining the result of the first operation directly from the register, and performing a scalar operation a second time using the result of the first operation obtained from the register.

In an seventh aspect of the invention, improved methods for increasing pipeline performance and efficiency by decoupling certain signals, and allowing an existing pipeline configuration to reveal more parallelism, are disclosed. The dataword fetch (e.g., ifetch) signal, which indicates the need to fetch instruction opcode/data from memory at the location being clocked into the program counter (pc) at the end of the current cycle, is made independent of the qualifying (validity) signal (e.g., ivalid). Additionally, the next program counter value signal (e.g., next_pc) is made independent of the data word supplied by the memory controller (e.g., pliw) and ivalid. The hazard detection logic and control logic of the pipeline is further made independent of ivalid; i.e., the stage 1, stage 2, and stage 3 enables (en1, en2, en3) are decoupled from the ivalid (and pliw) signals, thereby decoupling pipeline movement. So-called “structural stalls” are further utilized when a slow functional unit, or operand fetch in the case of the xy memory extension, generates the next program counter signal (next_pc). The jump instruction of the processor instruction set is also moved from stage 2 to 3, independent of ivalid. In this case, the jump address is held if the delay slot misses the cache and link. Additionally, delay slot instructions are not separated from their associated jump instruction.

In an eighth aspect of the invention, an improved data cache apparatus useful within a pipelined processor is disclosed. The apparatus generally comprises logic which allows the pipeline to advance one stage ahead of the cache. Furthermore, rather than assuming that the pipeline will need to be stalled under all circumstances as in prior art pipeline control logic, the apparatus of the present allows the pipeline to move ahead of the cache, and only stalls when a required data word is not provided (or other such condition necessitating a stall). Such conditional “latent” stalls enhance pipeline performance over the prior art configurations by eliminating conditions where stalls are unnecessarily invoked. In one exemplary embodiment, the pipelined processor comprises an extensible RISC-based processor, and the logic comprises (i) bypass operand selection logic disposed in the execution stage of the pipeline, and (ii) a multi-function register architecture.

In a ninth aspect of the invention, an improved method of reducing pipeline delays due to stalling using “latent” stalls is disclosed. The method generally comprises providing a processor having an instruction set and multistage pipeline; adapting the processor pipeline to move at least one stage ahead of the data cache, thereby assuming a data cache hit; detecting the presence of at least one required data word; and stalling the pipeline only when the required data word is not present.

In a tenth aspect of the invention, an improved processor architecture utilizing one or more of the foregoing improvements including “atomic” instruction words, improved bypass logic, delayed breakpoint instruction decode, improved data cache architecture, and pipeline “decoupling” enhancements, is disclosed. In one exemplary embodiment, the processor comprises a reduced instruction set computer (RISC) having a four stage pipeline comprising instruction fetch, decode, execute, and writeback stages, and “latent stall” data cache architecture which allows the pipeline to advance one stage ahead of the cache. In another embodiment, the processor further includes an instruction set comprising at least one breakpoint instruction, the decoding of the breakpoint instruction being accomplished within stage 2 of the pipeline. The processor is also optionally configured with a multi-function register in a bypass configuration such that the result of one iteration of an iterative calculation is provided directly as an operand for subsequent iterations.

### BRIEF DESCRIPTION OF THE DRAWINGS

FIG. 1 is functional block diagram of a prior art pipelined processor breakpoint instruction decode architecture (stage 1) illustrating the relationship between the instruction cache, instruction decode logic, and instruction request address selection logic.

FIG. 2 is block diagram of a prior art processor bypass logic architecture illustrating the relationship of the bypass logic to the single- and multi-cycle functional units and registers.

FIG. 3 is functional block diagram of a prior art pipelined processor data cache architecture illustrating the relationship between the data cache and associated execution stage logic.

FIG. 3a is graphical representation of pipeline movement within a typical prior art processor pipeline architecture.

FIG. 4 is block diagram illustrating a typical non-optimized prior art processor pipeline architecture and the relationship between various instructions and functional entities within the pipeline logic.

FIG. 4a is a block diagram of components and instruction flow within the non-optimized prior art processor design of FIG. 4.

FIG. 5 is logical flow diagram illustrating one embodiment of the long instruction word long immediate (limm) merge logic of the invention.

FIG. 6 is a block diagram of one embodiment of the modified pipeline architecture and related functionalities according to the present invention, illustrating the enhanced path independence and parallelism thereof.

FIG. 7 is a functional block diagram of one exemplary embodiment of the pipeline logic arrangement of the invention, illustrating the decoupling of the ivalid and pliw signals from the various other components of the pipeline logic.

FIG. 8 is functional block diagram of one embodiment of the breakpoint instruction decode architecture (stage 1) of the present invention, illustrating the relationship between the instruction cache, instruction decode logic, and instruction request address selection logic.

FIG. 8a is a graphical representation of the movement of the pipeline of an exemplary processor incorporating the improved breakpoint instruction logic of the invention, wherein a breakpoint instruction located with in a delay slot.

FIG. 8b is a graphical representation of pipeline movement wherein a breakpoint instruction normally handled within the pipeline when a delay slot is not present.

FIG. 8c is a graphical representation of pipeline movement during stalled jump and branch operation according to the present invention.

FIG. 9 is block diagram of one embodiment of the improved bypass logic architecture of the present invention, illustrating the use of a multi-function register within the execute stage of the pipeline logic between the bypass operand selection logic and the single- and multi-cycle functional units.

FIG. 10 is a logical flow diagram illustrating one embodiment of the method of utilizing bypass logic to maximize processor performance during iterative calculations (such as sum-of products) according to the invention.

FIG. 11 is a block diagram illustrating one exemplary embodiment of the modified data cache structure of the present invention.

FIG. 11a is a graphical representation of pipeline movement in an exemplary processor incorporating the improved data cache integration according to the present invention.

FIG. 12 is logical flow diagram illustrating the one exemplary embodiment of the method of enhancing the performance of a pipelined processor design according to the invention.

FIG. 13 is a logical flow diagram illustrating the generalized methodology of synthesizing processor logic using a hardware description language (HDL), the synthesized logic incorporating the pipeline performance enhancements of the present invention.

FIG. 14 is a block diagram of an exemplary RISC pipelined processor design incorporating various of the pipeline performance enhancements of the present invention.

FIG. 15 is a functional block diagram of one exemplary embodiment of a computer system useful for synthesizing gate logic implementing the aforementioned pipeline performance enhancements within a digital processor device.

### DETAILED DESCRIPTION

Reference is now made to the drawings wherein like numerals refer to like parts throughout.

As used herein, the term “processor” is meant to include any integrated circuit or other electronic device capable of performing an operation on at least one instruction word including, without limitation, reduced instruction set core (RISC) processors such as the ARC™ user-configurable core manufactured by the Assignee hereof, central processing units (CPUs), and digital signal processors (DSPs). The hardware of such devices may be integrated onto a single piece of silicon (“die”), or distributed among two or more die. Furthermore, various functional aspects of the processor may be implemented solely as software or firmware associated with the processor.

Additionally, it will be recognized by those of ordinary skill in the art that the term “stage” as used herein refers to various successive stages within a pipelined processor; i.e., stage 1 refers to the first pipelined stage, stage 2 to the second pipelined stage, and so forth.

It is also noted that while the following description is cast in terms of VHSIC hardware description language (VHDL), other hardware description languages such as Verilog® may be used to describe various embodiments of the invention with equal success. Furthermore, while an exemplary Synopsys® synthesis engine such as the Design Compiler 2000.05 (DC00) is used to synthesize the various embodiments set forth herein, other synthesis engines such as Buildgates® available from, inter alia, Cadence Design Systems, Inc., may be used. IEEE std. 1076.3-1997, IEEE Standard VHDL Synthesis Packages, describe an industry-accepted language for specifying a Hardware Definition Language-based design and the synthesis capabilities that may be expected to be available to one of ordinary skill in the art.

Lastly, it is noted that as used in this disclosure, the terms “breakpoint” and “breakpoint instruction” refer generally that class of processor instructions which result in an interrupt or halting of at least a portion of the execution or processing of instructions within the pipeline or associated logic units of a digital processor. As discussed in greater detail below, one such instruction comprises the “Brkₓ” class of instructions associated with the ARC™ extensible RISC processor previously referenced; however, it will be recognized that any number of different instructions meeting the aforementioned criteria may benefit from the methodology of the present invention.

It will be noted that while the various methodologies of the invention are described herein in terms of a particular sequence of steps, such descriptions are only exemplary of the broader methods. Accordingly, the sequence of performace of such steps may in many cases be permuted, and/or additional steps added. Other steps may be optional. All such variations are considered to fall within the scope of the claims appended hereto.

Overview

Pipelined CPU instruction decode and execution is a common method of providing performance enhancements for CPU designs. Many CPU designs offer programmers the opportunity to use instructions that span multiple words. Some multi-word instructions permit a greater number of operands and addressing modes, while others enable a wider range of immediate data values. For multi-word immediate data, pipelined execution of instructions has some built-in limitations. As previously discussed, one of these limitations is the potential for an instruction containing long immediate data to be impacted by a pipeline stall before the long immediate data has been completely fetched from memory. This stalling of an incompletely fetched piece of data has several ramifications, one of which is that the otherwise executable instruction may be stalled before it is necessary. This leads to increased execution time and overhead, thereby reducing processor performance.

The present invention provides, inter alia, a way to avoid the stalling of long immediate data instructions so that performance is maximized. The invention further eliminates a critical path delay in a typical pipelined CPU by treating certain multi-word long immediate data instructions as a larger or “atomic” multi-word oversized instruction. These larger instructions are multi-word format instructions such as those employing long immediate data. Typical instruction types for the oversized instructions disclosed herein include “load immediate” and “jump” type instructions.

Processor instruction execution time is critical for many applications; therefore, minimizing so-called “critical paths” within the decode phase of a multi-stage pipelined processor is also an important consideration. One approach to improving performance of the CPU in all cases is removing the speed path limitations. The present invention accomplishes removal of such path limitations by, inter alia, reducing the number of critical path delays in the control logic associated with instruction fetch and decode, including decode of breakpoint instructions used during processes such as debug. By moving the breakpoint instruction decode from stage 1 (as in the prior art) to stage 2, the present invention eliminates the speed path constraint imposed by the breakpoint instruction; stage 1 instruction word decoding is advantageously removed from the critical path.

Delays in the pipeline are further reduced using the methods of the present invention through modifications to the pipeline hazard detection and control logic (and register structure), which effectively reveal more parallelism in the pipeline. Pipelining of operations which span multiple cycles is also utilized to increase parallelism.

The present invention further advantageously permits the data cache to be integrated into the processor core in a manner that allows the pipeline to advance one stage ahead of the data cache. In the particular case of the aforementioned ARC™ extensible RISC processor manufactured by the Assignee hereof, since the valid signal for returning loads (i.e., “ldvalid”) does not necessarily influence pipeline movement, it can be assumed that the data cache will “hit” (i.e., contain the appropriate data value when accessed). Such cache hit allows the pipeline to move on to conduct further processing. If this assumption is wrong, and the requested data word is needed by an execution unit in stage 3, the pipeline can then be stalled. This “latent stall” approach improves pipeline performance significantly, since stalls within the pipeline due to cache “misses” are invoked only on an as-needed basis.

Appendix I provides detailed logic equations in HDL format detailing the method of the present invention in the context of the aforementioned ARC™ extensible RISC processor core. It will be recognized, however, that the logic equations of Appendix I (and those specifically described in greater detail below) are exemplary, and merely illustrative of the broader concepts of the invention.

While each of the improvement elements referenced above may be used in isolation, it should be recognized that these improvements advantageously may be used in combination. In particular, the combination of an instruction memory cache with the bypass logic will serve to maximize instruction execution rates. Likewise, the use of a data cache minimizes data related processor stalls. Combining the breakpoint function with memory caches mitigates the impact of the breakpoint function. Selection of combinations of these functions compromises complexity with performance. It will be appreciated that the choice of functions may be determined by a number of factors including the end application for which the processor is designed.

Atomic Instructions

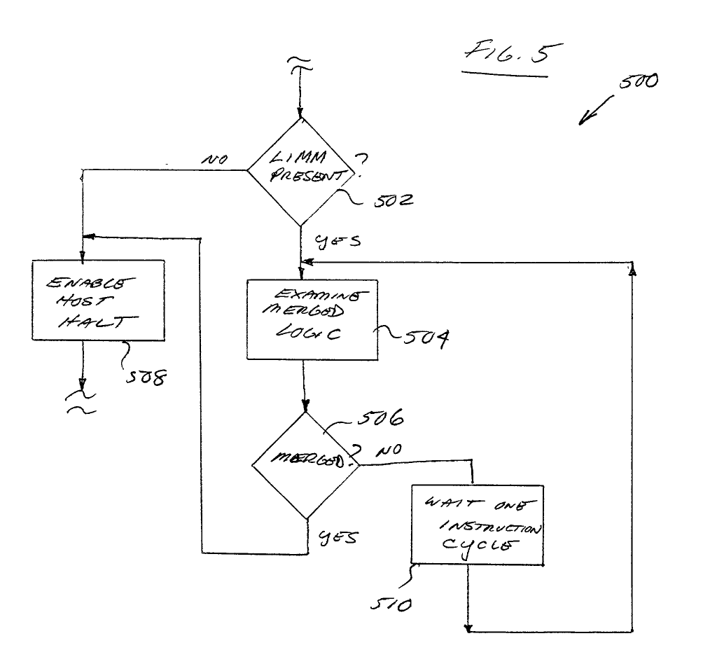

The invention in one aspect prevents enabling the host to halt the core while an instruction with long immediate values in stage 2 has not merged. This results in making the instructions containing long immediate data non-stallable on the boundary between the instruction opcode and the immediate data. Consequently the instruction containing long immediate data is treated as if the CPU was wider in word width for that instruction only. The foregoing functionality is specifically accomplished within the ARC™ core by connecting the hold_host value to the instruction merge logic, i.e. p2_merge_valid_r and p2limm. FIG. 5 illustrates one exemplary embodiment of the logical flow of this arrangement. The method 500 generally comprises first determining whether an instruction with long immediate (limm) data is present (step 502); if so the core merge logic is examined to determine whether merging in stage 2 of the pipeline has occurred (step 504). If merging has occurred (step 506), the halt signal to the core is enabled (i.e., “halt permissive” per step 508), thereby allowing the core to be halted at any time upon initiation by the host. If merging has not occurred per step 506, then the core waits one instruction cycle (step 510) and then re-examines the merge logic to determine if merging has occurred. Accordingly, long immediate instructions cannot be stalled unless merging has occurred, which effectively precludes stalling on the instruction/immediate data word boundary.

Appendix I hereto provides detailed logic equations (rendered in hardware description language) of one exemplary embodiment of the functionality of FIG. 5, specifically adapted for the aforementioned ARC core manufactured by the Assignee hereof.

Enhanced Parallelism

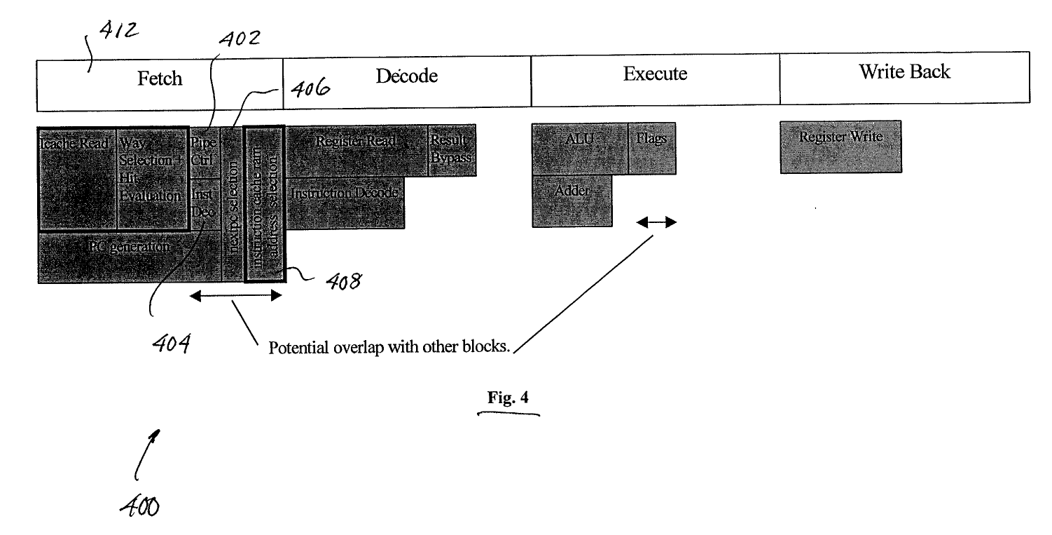

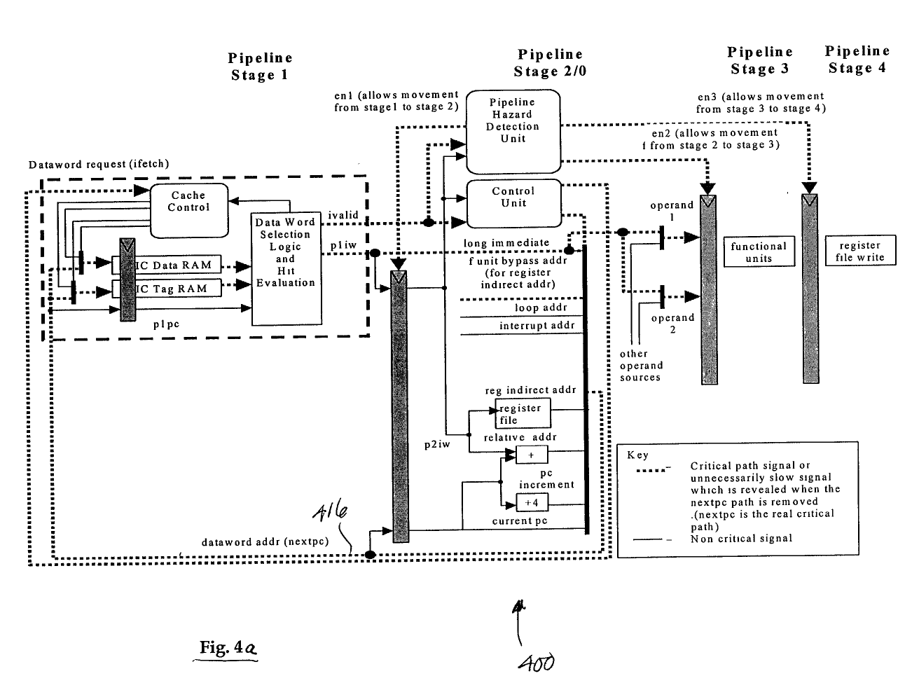

As previously shown in FIG. 4, the speed of each pipeline stage in the non-optimized prior art pipeline structure is bound by the slowest stage. Some functional blocks within the instruction fetch pipeline stage of the processor are not optimally placed within the pipeline structure.

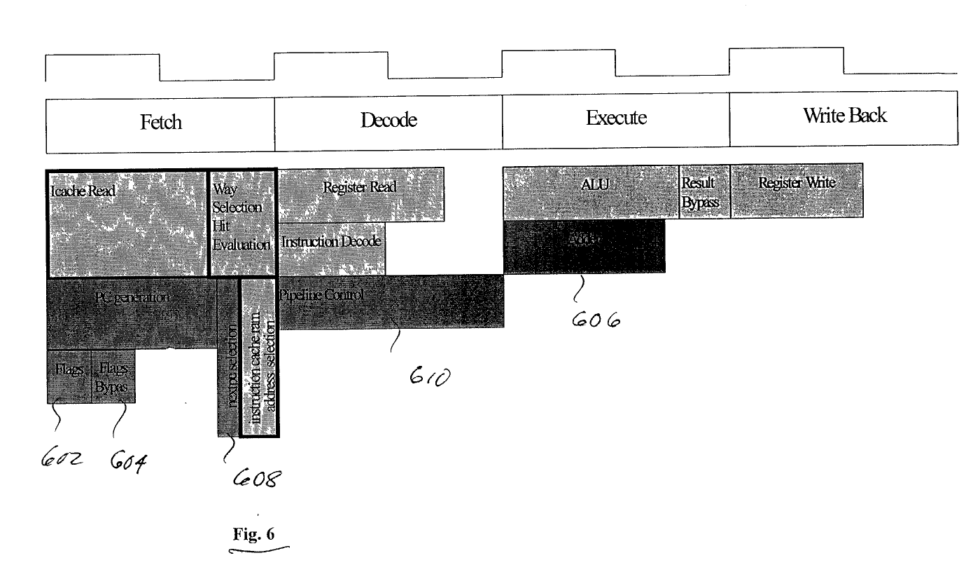

FIG. 6 illustrates the impact on pipeline operation of the methods of enhanced parallelism according to the present invention. The dark shaded blocks 602, 604, 606, 608, 610 show areas of modification. These modifications, when implemented, produce significant improvements to the maximum speed of the core. Specifically, full pipelining of the blocks as in the present embodiment allows them to overlap with other blocks, and hence their propagation delay is effectively hidden. It is noted that these modifications do not change the instruction set architecture (ISA) in any way, but do produce slight changes in the timing of 64-bit instructions, instructions in delay slots, and jump indirect instructions which could need to bypass data words from slow execution units to generate nextpc.

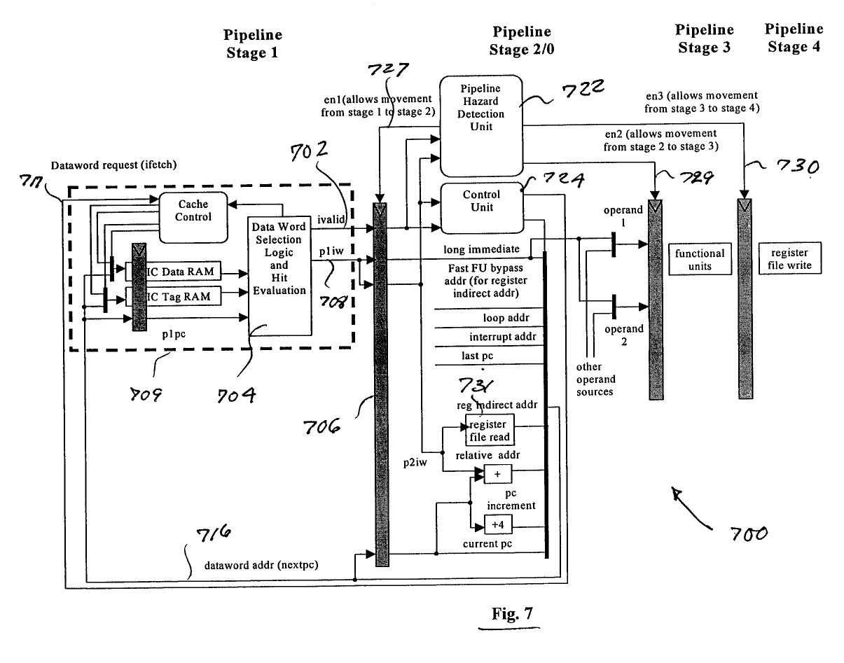

FIG. 7 is a block diagram of the modified pipeline architecture 700 according to one embodiment of the invention. In the modified architecture of FIG. 7, the slow cache path does not influence the control path (unlike that of the prior art approach of FIGS. 4 and 4a), thereby reducing processor pipeline delays. Specifically, the ivalid signal 702 produced by the data word selection and cache “hit” evaluation logic 704 is latched into the first stage latch 706. Additionally, the long immediate instruction word (pliw) signal 708 resulting from the logic 704 is latched into the first stage latch 706.

Using the arrangement of FIG. 7, the dataword fetch (ifetch) signal 717, which indicates the need to fetch instruction opcode or data from memory at the location being clocked into the program counter (pc) at the end of the current cycle, is decoupled or made independent of the ivalid signal 702. This results in the instruction cache 709 ignoring the ifetch signal 717 (except when a cache invalidate is requested, or on start-up).

Additionally, due to the latching arrangement of FIG. 7, the next program counter signal (nextpc) 716, which is indicative of the dataword address, is made independent of the word supplied by the memory controller (pliw) 708 and ivalid 702. Using this approach, nextpc is only valid when ifetch 717 is true (i.e., required opcode or dataword needs to be fetched by the memory controller) and ivalid is true (apart from start-up, or after an ivalidate). Note that the critical path signal or unnecessarily slow signal is readily revealed when the “nextpc” path 416 is removed (dotted flow lines of FIG. 4a).

The hazard detection logic 722 and pipeline control logic 724 is further made independent of the ivalid signal 702; i.e., the stage 1, stage 2, and stage 3 enables (en1 727, en2 729, and en3 730, respectively) are decoupled from the ivalid signal 702. Therefore, influence on pipeline movement by ivalid 702 is advantageously avoided.

Instructions with long immediate data are merged in stage 2. This merge at stage 2 is a consequence of the foregoing independence of the hazard logic 722 and control logic 724 from ivalid 702; since these instructions with long immediate data are made up of multiple multi-bit words (e.g., two 32-bit data words), two accesses of the instruction cache 709 are needed. That is, an instruction with a long immediate should not move to stage 3 until both the instruction and long immediate data are available in stage 2 of the pipeline. This requirement is also imposed for jump instructions with long immediate data values. In current practice, the instruction opcode comes from stage 2 and the long immediate data from stage 1 when a long immediate instruction is issued, that is, when the instruction moves to stage 3.

The present invention further utilizes “structural stalls” to enhance pipeline performance such as when a slow functional unit (or operand fetch in the case of the xy memory extension) generates nextpc 716 (that is, jump register indirect instructions, j [rx], where the value of rx can be bypassed from a functional unit). As used herein, the term “structural stalls” refers to stall requirements that are defined by limitations inherent in the functional unit. One example of a structural stall is the operand fetch associated with the XY memory extension of the ARC processor. This approach advantageously allows slow forwarding paths to be removed, by prematurely stalling the impeding operation. For example, new program counter (pc) values are rarely generated by multipliers; if such values are generated by the multiplier, they can result in a cycle delay that is a 1 cycle stall or bubble, and allow next_pc to be obtained from the register file 731. In general, the present invention exploits the stall that is inherent in generating a next PC address which is not sequentially linear in the address space. This occurs when a new PC value is calculated by an instruction such as jump. In addition, it may be appreciated that certain instruction sets permit arithmetic and logic operations to directly a new PC. Such computations also introduce a structural stall which under some circumstances may be exploited to continue operation of the CPU.

In addition to the foregoing, the present invention further removes or optimizes remaining critical paths within the processor using selective pipelining of operations. Specifically, paths that can be extended over more than one processor cycle with no processor performance loss can be selectively pipelined if desired. As an example, the process of (i) activating sleep mode, (ii) stopping the core, and (iii) detecting a breakpoint instruction, does not need to be performed in a single cycle, and accordingly is a candidate for such pipelining.

Breakpoint Instruction Decode Architecture

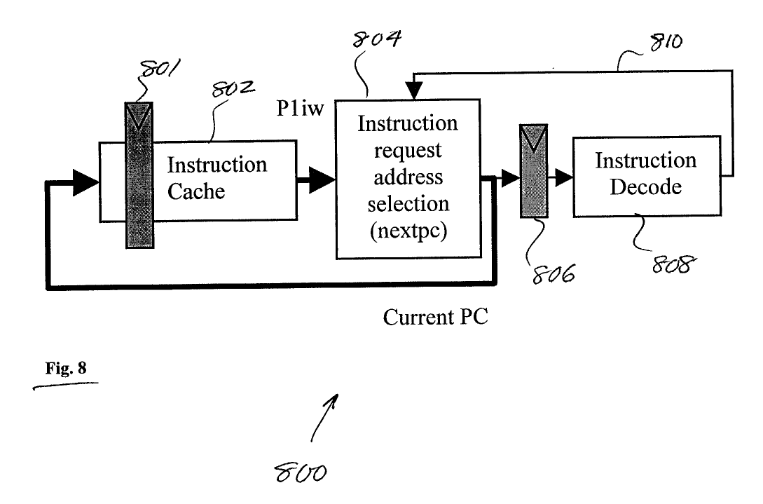

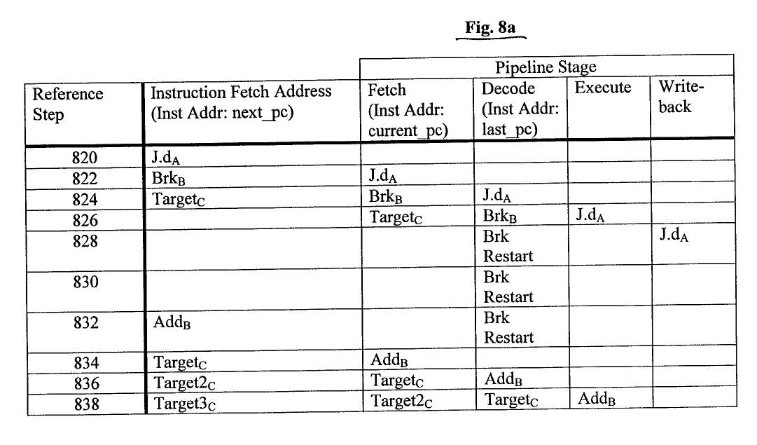

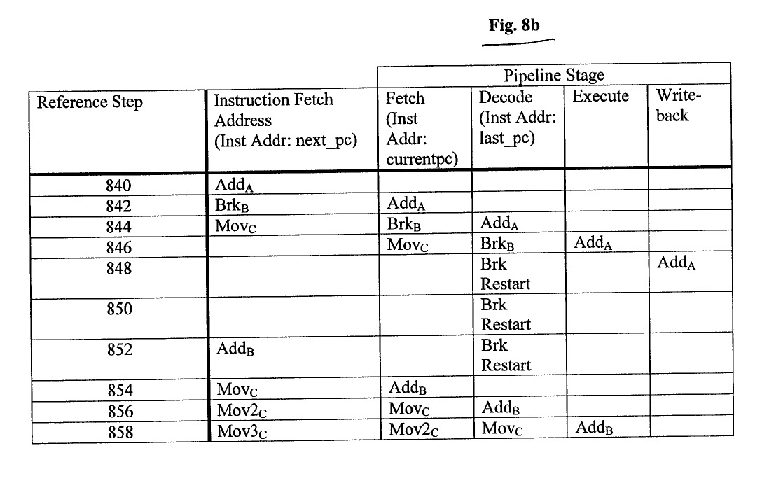

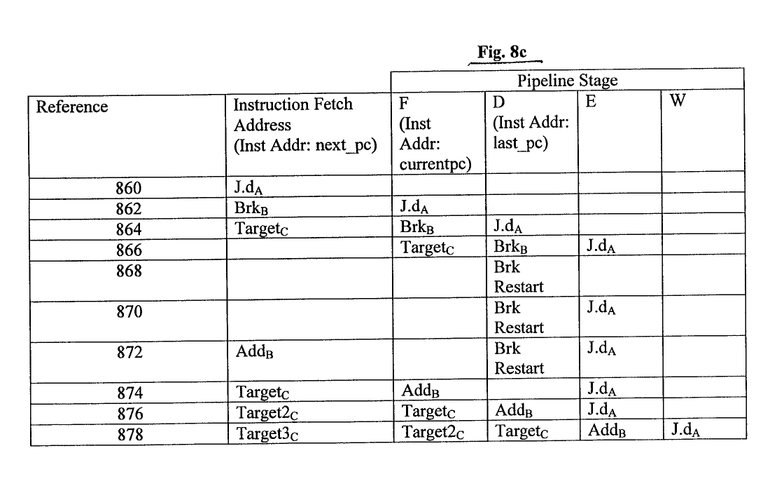

Referring now to FIG. 8, one embodiment of the modified breakpoint architecture of the invention is described. As illustrated in FIG. 8, the architecture 800 comprises generally a first stage latch (register) 801, an instruction cache 802, instruction request selection logic 804, an intermediate (e.g., second stage) latch 806, and instruction decode logic 808. The instruction cache 802 stores or caches instructions received from the latch 801 which are to be decoded by the instruction decode logic 808, thereby obviating at least some program memory accesses. The design and operation of instruction (program) caches is well known in the art, and accordingly will not be described further here. The instruction word(s) stored within the instruction cache 802 is/are provided to the instruction request address selection logic 804, which utilizes the program counter (nextpc) register to identify the next instruction to be fetched, based on data 810 (e.g., 16-bit word) from the instruction decode logic 808 and the current instruction word. This data includes such information as condition codes and other instruction state information, assembled into a logical collection of information which is not necessarily physically assembled. For example, a condition code by itself may select an alternative instruction ot be fetched. The address from which the instruction is to be fetched may be identified by a ariety of words such as the contents of a register or a data word from memory. The instruction word provided to the instruction request logic 804 is then passed to the intermediate latch 806, and read out of that latch on the next successive clock cycle by the instruction decode logic 808.

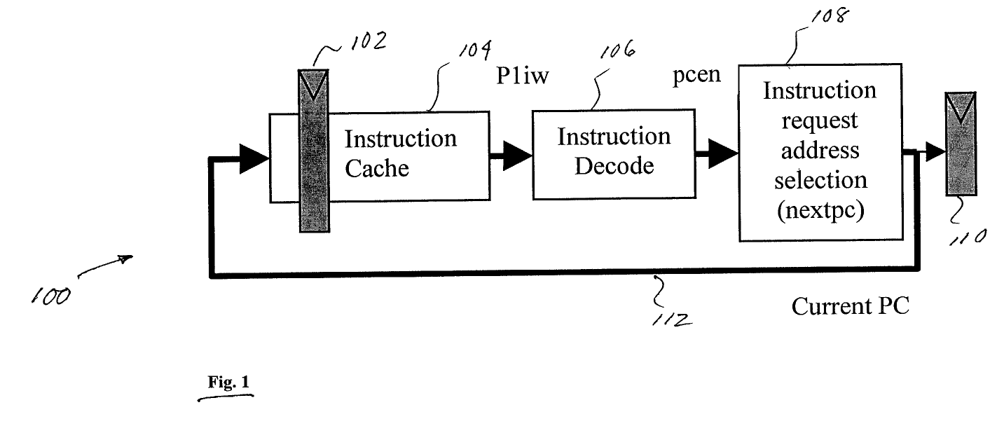

Hence, in the case of a breakpoint instruction, the decode of the instruction (and its subsequent execution) in the present embodiment is delayed until stage 2 of the pipeline. This is in contrast to the prior art decode arrangement (FIG. 1), wherein the instruction decode logic 808 is disposed immediately following the instruction cache 802, thereby providing for immediate decode of a breakpoint instruction after it is moved out of the instruction cache 802 (i.e., in the first stage), which places the decode operation in the critical path.

Additionally, in order to move the breakpoint instruction decode to stage 2 as described above, the program counter (pc) of the present embodiment is changed from the current value to the breakpoint pc value through a simple assignment. This modification is required based on timing considerations; specifically, by the time the breakpoint instruction is decoded, the pc has already been updated to point to the next instruction. Hence, the pc value must be “reset” back to the breakpoint instruction value to account for this decoding delay.

The following examples illustrate the operation of the modified breakpoint instruction decode architecture of the present invention in detail.

Example 1—Delay Slot

FIG. 8a and the discussion following hereafter illustrate how a breakpoint instruction located with in a delay slot is processed using the present invention. As is well known in the digital processing arts, delay slots are used in conjunction with certain instruction types for including an instruction which is executed during execution of the parent instruction. For example, a “jump delay slot” is often used to refer to the slot within a pipeline subsequent to a branching or jump instruction being decoded. The instruction after the branch (or load) is executed while awaiting completion of the branch/load instruction. It will be recognized that while the example of FIG. 8a is cast in terms of a breakpoint instruction disposed in the delay slot after a “Jump To” instruction, other applications of delay slots may be used, whether alone or in conjunction with other instruction types, consistent with the present invention.

Note that as used herein, the nomenclature“<name>_{<Address>}” refers to the instruction name at a given address. For example, “J.d_{A}” refers to a “Jump To” instruction at address A.

In step 820 of FIG. 8a, an instruction (e.g, “Jump To” at address A, or “J.d_{A}”) is requested. Next, the breakpoint instruction at address B (Brk_{B}) is requested in step 822. In step 824, the target address at address C (Target_{c}) is requested. The target address is saved in the second operand register or the long immediate register of the processor in the illustrated example. The instruction in the fetch stage is killed.

Next, in step 826, the breakpoint instruction of step 822 above (Brk_{B}) is decoded. The current pc value is updated with the value of lastpc, the address of Brk_{B} rather than the address of Target_{c}, as previously described. An extra state is also implemented in the present embodiment to indicate (i) that a ‘breakpoint restart’ is needed, and (ii) if the breakpoint instruction was disposed in a delay slot (which in the present example it is).

In step 828, the “Jump To” instruction J.d_{A} completes, and once all other multi-cycle instructions have completed, the core is halted, reporting a break instruction. Next, in step 830, the host takes control and changes Brk_{B} to Add_{B} (for example, by a “write” to main memory). The host then invalidates the memory mapping of address B by either invalidating the entire cache or invalidating the associated cache line. The host then starts the core running.

After the core is running, the add instruction at address B, Add_{B,} is fetched using the current program counter value (currentpc) in step 832. Then, in step 834, the target value at address C (Target_{c}) is requested, using the target address from stage 3 of the pipeline. The current program counter value (currentpc) is set equal to the Target_{c} address. In step 836, Target2_{c} is requested. Lastly, in step 838, the Target3_{c} is requested.

Note that in the example of FIG. 8a above, the breakpoint instruction execution is complicated by the presence of a delay slot. This requires the processor to restart operation at the delay slot after the completion of the breakpoint instruction. The instruction at the delay slot address is then executed, followed by the instruction at the address specified by the jump instruction. The program continues from the target address.

Example 2 Non delay Slot Breakpoint Use

FIG. 8b and subsequent discussion illustrate how a breakpoint instruction is normally handled within the pipeline when a delay slot is not present.

First, in step 840, an add at address A (Add_{A}) is requested. A breakpoint instruction at address B (Brk_{B}) is then requested in step 842. A “move” at address C (Mov_{c}) is next requested in step 844. The instruction in the fetch stage (stage 1) is killed. The breakpoint instruction (Brk_{B}) is next decoded in step 846. The current pc value is updated with the value of lastpc, i.e., the address of Brk_{B} rather than the address of the instruction following Mov_{c}. Mov_{c} is killed.

Next, in step 848, the Add_{A} instruction completes, and once all other multi cycle instructions (including delayed loads) have completed, the processor is halted, reporting a break instruction. The host then takes control in step 850, changing Brk_{B} to Add_{B} (such as by a write to main memory). The host then invalidates the memory mapping of address B by either invalidating the entire cache or invalidating the associated cache line. The host then starts the core running again per step 850.

In step 852, the add instruction at address B (Add_{B}) is fetched using the current address in the program counter (currentpc). A move at address C (Mov_{c}) is again requested in step 854. Mov2_{c} is then requested in step 856, and lastly Mov3_{c} is requested in step 858.

Example 3—Stalled Jump and Branches

Referring now to FIG. 8c, in step 860, the jump instruction J.d_{A} is requested. The breakpoint instruction (Brk_{B}) is next requested in step 862. Target_{c} is next requested in step 864. The target address is saved in the second operand register or the long immediate register in the illustrated embodiment, although it will be recognized that other storage locations may be utilized.

The breakpoint instruction (Brk_{B}) is next decoded in step 866. Current pc is updated with the value of lastpc, the address of Brk_{B} rather than the address of Target_{c}. As with the example of FIG. 8b above, an extra state is added to indicate (i) that a ‘breakpoint restart’ is needed, and (ii) if the breakpoint instruction was in a delay slot. The “Jump To” instruction J.d_{A} is stalled in stage 3 since, inter alia, it may be a link jump. Once all other multi cycle instructions have completed the core is halted, and a break instruction reported. In step 868, the host takes control and changes Brk_{B} to Target_{c}. The host then invalidates the memory mapping of address B by either invalidating the entire cache or invalidating the associated cache line. The host then starts the core running in step 870.

The add instruction at address B (Add_{B}) is next fetched using the address of the currentpc. In step 874, Target_{c} is requested, using the target address from stage 3 (execute) of the pipeline. The currentpc address is set equal to the Target_{c} address. Target2_{c} is then requested per step 876, and Target3_{c} is requested per step 878.

Note that in the example of FIG. 8c, the breakpoint instruction is disposed in a delay slot, but the processor pipeline is stalled. The breakpoint instruction is held for execution until the multi-cycle instructions have completed executing. This limitation is imposed to prevent leaving the core in a state of partial completion of a multi-cycle instruction during the breakpoint instruction execution.

Bypass Logic

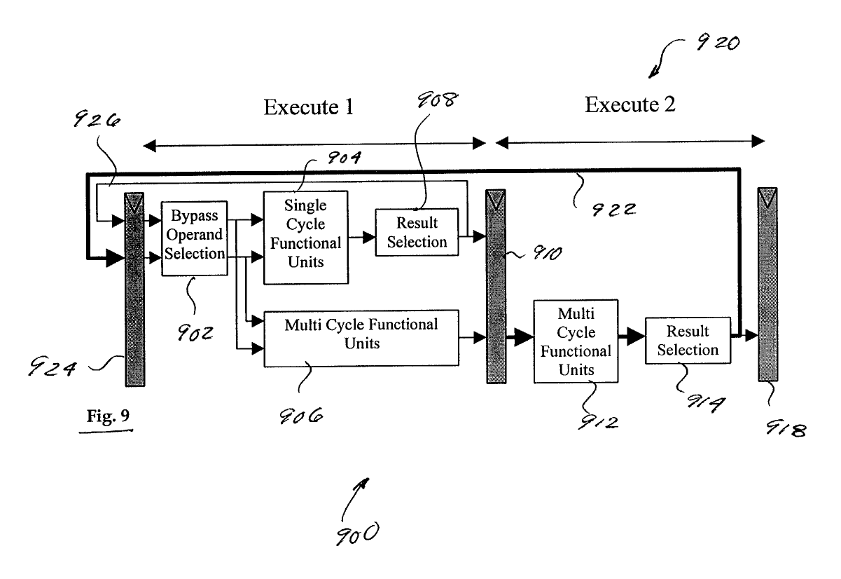

Referring now to FIG. 9, the bypass logic 900 of the present invention comprises bypass operand selection logic 902, one or more single cycle functional units 904, one or more multi-cycle functional units 906, result selection logic 908 operatively coupled to the output of the single cycle functional units, a register 910 coupled to the output of the result selection logic 908 and the multi-cycle functional units 906, and more multi-cycle functional units 912 and result selection logic 914 coupled sequentially to the output of the register 910 as part of the second execute stage 920. A second register 918 is also coupled to the output of the result selection logic 914. A return path 922 connects the output of the second stage result selection logic 914 to the input of a third “multi-function” register 924, the latter providing input to aforementioned bypass operand selection logic 902. A similar return path 926 is provided from the output of the first stage result selection logic 908 to the input of the third register 924. As used herein, the term “single-cycle” refers to instructions which have only one execute stage, while the term “multi-cycle” refers to instructions having two or more execute stages. Of particular interest are the instructions that are multi-cycle by virtue of a need to load long immediate data. These instructions are formed, e.g., by two sequential instruction words in the instruction memory. The first of the words generally includes the op-code for the instruction, and potentially part of the long immediate data. The second word is made up of all (or the remainder) of the long immediate data.

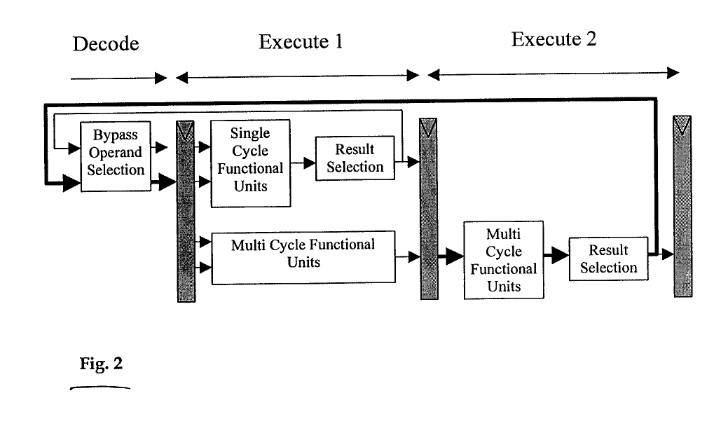

By employing the bypass arrangement of FIG. 9, the present invention replaces the register or memory location used in prior art systems such as that illustrated in FIG. 2 with a special register 924 that serves multiple purposes. When used in a “bypass” mode, the special register 924 retains the summation result and presents the summation result as a value to be selected from by an instruction. The result is a software loop that can execute nearly as fast as custom-built hardware. The execution pipeline fills with the instructions to perform the sum of products operation and the bypass logic permits the functional units to operate at peak speed without any additional addressing of memory. Other functions of this register 924 (in addition to the aforementioned “bypass” mode operation) include (i) latching the source operands to permit fully static operation, and (ii) providing a centralized location for synchronization signal/data movement.

As can be seen from FIG. 9, the duration for single cycle instructions in the present embodiment of the pipeline is unchanged as compared to that for the prior art arrangement (FIG. 2); however, multi-cycle instructions benefit from the pipeline arrangement of the present invention by effectively removing the bypass logic during the last cycle of the multi-cycle execution. Note that in the case of single cycle instructions, the bypass logic is not on the critical path because the datapath is sequenced to permit delay-free operation. By moving the latches (register) 924 to the front of the datapath as in FIG. 9, the second and subsequent cycles required for instruction execution are provided with additional time. This additional time comes from the fact that there are no additional decoding delays associated with the logic for the functional units and operand selection, and because the register 924 may be clocked by a later pipeline stage. Since a later stage clock signal may be used to clock the register, the register latching is accomplished prior to the clock signal associated with the operand decode logic. Hence, the operand decode logic is not “left waiting” for the latching of the register 924.

In one exemplary design of the ARC™ core incorporating the bypass logic functionality of the invention as described above with respect to FIG. 9, the decode logic 900 and functional units 904, 906 are constrained to be minimized simultaneously. This constraint during design synthesis advantageously produces one fewer level of gate delay in the datapath as compared to the design resulting if such constraint is not imposed, thereby further enhancing pipeline performance. It will be appreciated that this refinement is not neceaasry to practice the essence of the invention, but serves to further the perfromance enhancement of the invention.

The results of the previous operation (specifically, in the forgoing sum-of-products example, the sum from a given iteration) are provided to the multi-function register 924 which in turn provides the sum value directly to the input of the bypass operand selection logic 902. In this fashion, the bypass operand selection logic 902 is not required to access a memory location or another register repeatedly to provide the operands for the summation operation.

It is also noted that the present invention may advantageously be implemented “incrementally” by moving lesser amounts of the bypass logic to the execution stage (e.g., stage 3). For example, rather than moving all bypass logic to stage 3 as described above, only the logic associated with bypassing of late arriving results of functional units can be moved to stage 3. It will be appreciated that differing amounts of logic optimization will be obtained based on the amount of bypass logic moved to stage 3.

In addition to the structural improvement in performance as previously described (i.e., obviating memory/register accesses during each iteration of multi-cycle instructions, thereby substantially reducing the total number of memory/register accesses performed during any given iterative calculation), there are several additional benefits provided by employing the bypass logic arrangement of the present invention. One such benefit is that by removing the interposed register between the bypass operand selection and the functional units (shown in FIG. 2), design compilers can better optimize the generated logic to maximize speed and/or minimize the number of gates in the design. Specifically, the design compiler does not have to consider and account for the presence of the register interposed between the bypass operand selection logic and the single/multi-cycle functional units.

Another benefit is that by grouping the registers and logic in the improved fashion of FIG. 9, the bypass function is better isolated from the rest of the design. This makes VHDL simulations potentially execute faster and simplifies fault analysis and coverage.

In sum, two primary benefits are derived from the improved bypass logic design described above. The first benefit is the ability to manage late arriving results from the functional units more efficiently. The second benefit is that there is better logic optimization within the device.

The first benefit may be obtained by only moving the minimum required portion of the logic to the improved location. The second benefit may be attained in varying degrees by the amount of logic that is moved to the new location. This second benefit derives at least in part from the synthesis engine's improved ability to optimize the results. The ability to optimize the results stems from the way in which the exemplary synthesis engine functions. In specific, synthesis engines generally treat all logic between registers as a single block to be optimized. Blocks that are divided by registers are optimized only to the registers. By moving the operand selection logic so that no registers are interposed between it and the functional unit logic, the synthesis engine can perform a greater degree of optimization.

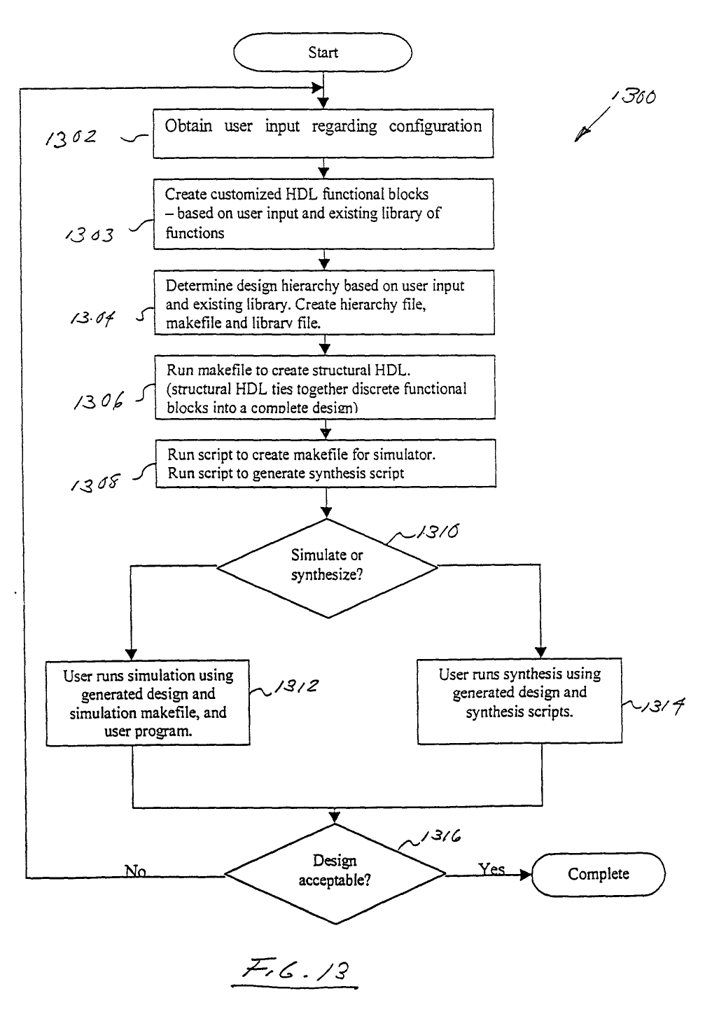

More detail on the design synthesis process incorporating the bypass logic of the present invention is provided herein with respect to FIG. 13.

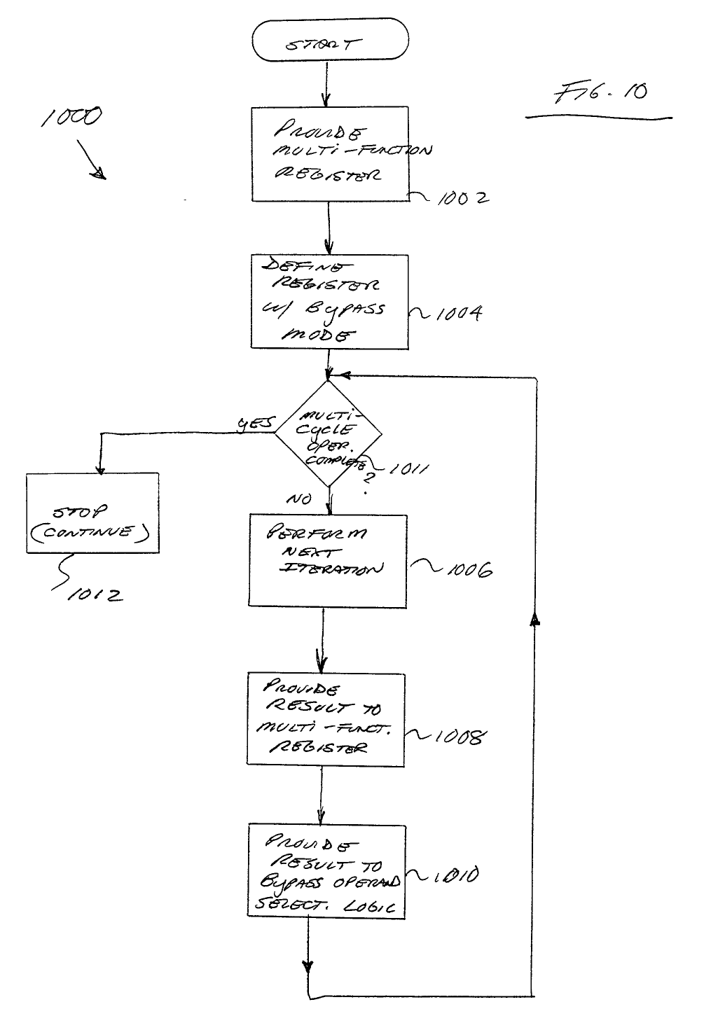

Referring now to FIG. 10, a method for operating the pipeline of a pipelined processor which facilitates the bypass of various components and registers so as to maximize processor performance during iterative operations (e.g., sum of products) is disclosed. The first step 1002 of the method 1000 comprises providing a multi-function register 914 such as that described with respect to FIG. 9 above. This register is defined in step 1004 to include a “bypass mode”, wherein during such bypass mode the register maintains the result of a multi-cycle scalar operation therein. In this fashion, the bypass operand selection logic 902 is not required to access memory or another location to obtain the operand (e.g., Sum value) used in the iterative calculation as in prior art architectures. Rather, the operand is stored by the register 914 for at least a part of one cycle, and provided directly to the bypass operand selection logic using decode information from the instruction to select register 914 directly without the need for any address generation. This type of register access differs from the general purpose register access present in RISC CPUs in that no address generation is required. General purpose register access requires register specification and/or address generation which consumes a portion of an instruction cycle and requires the use of the address generation resource of the CPU. The register employed in the bypass logic is an “implied” register that is specified by the instruction being executed without the need for a separate register specification. For certain instructions the registers of the datapath may function the same as an accumulator or other register. The value stored in the datapath register is transferred to a general purpose register during a later phase of the pipeline operation. In the meantime, iteration or other operations continue to be processed at full speed.

Next, in step 1006, a multi-cycle scalar operation is performed by the processor a first time. In the foregoing example of the sum-of-products calculation, such an operation comprises one iteration of the “Multiply” and “Sum” sub-operations, the result of the Sum sub-operation being provided back to the multi-function register 914 per step 1008 for direct use in the next iteration of the calculation.

In step 1010, the result of the previous iteration is provided directly from the register 914 to the bypass operand selection logic 902 via a bus element.

Lastly, a second iteration of the operation is performed using the result of the first operation from the register 914, and another operand supplied by the address generation logic of the RISC CPU. The iterations are continued until the multi-cycle operation is completed (step 1011), and the program flow stopped or other wise continued (step 1012).

Data Cache Integration

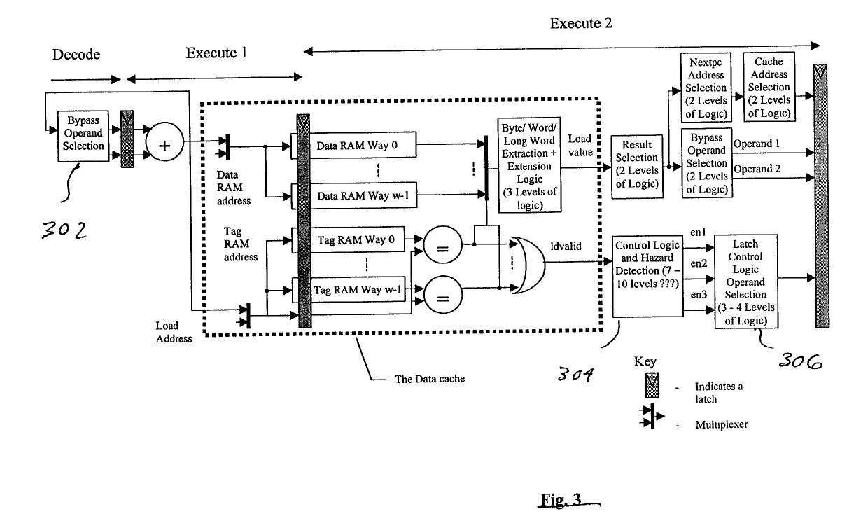

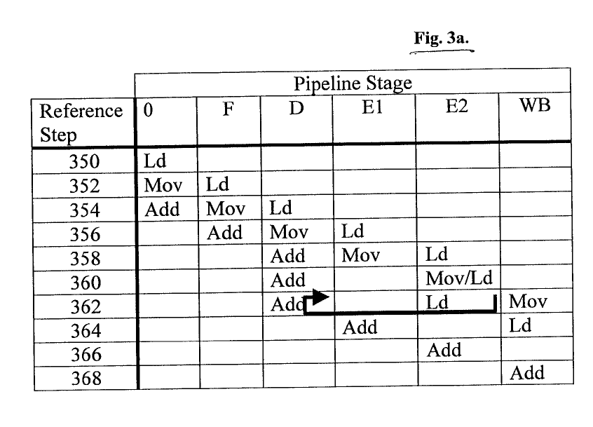

Integration of the data cache can have a profound effect on the speed of the processor. In general, the modified control of the data cache according to the present invention is accomplished through data hazard control logic modifications. The following discussion describes several enhancements to the prior art data cache integration scheme of FIG. 3 made by the present invention, including (i) assumption of data cache “hit” unless a “miss” actually occurs; (ii) improved instruction request address generation; and (iii) relocation of bypass logic from stage 2 (decode) to stage 3 (execute). It should also be noted that some of these modifications provide other benefits in the operation of the core in addition to improved pipeline performance, such as lower operating power, reduced memory accesses, and improved memory performance.

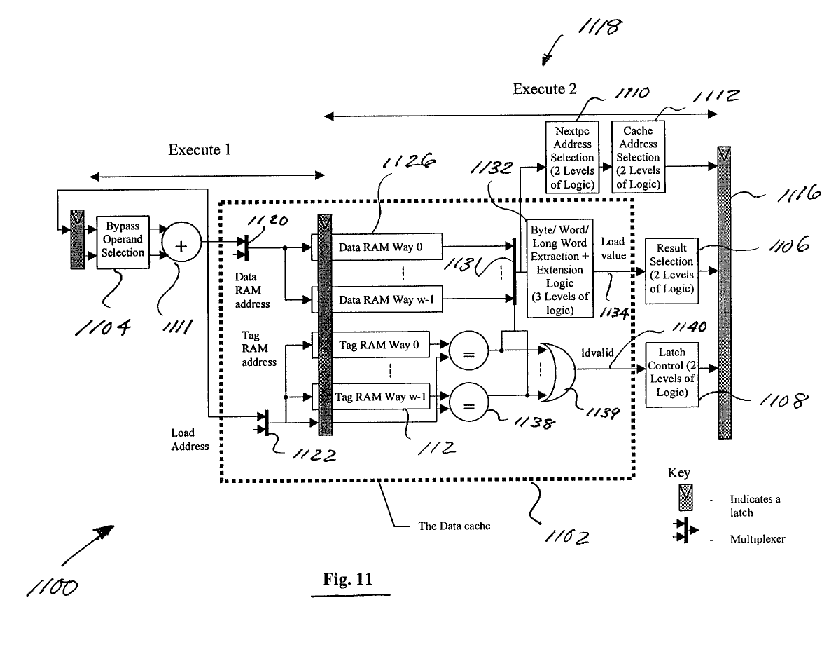

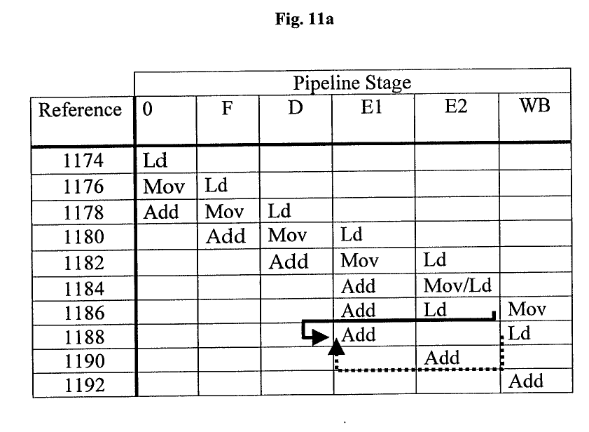

Referring now to FIGS. 11 and 11a, the improved data cache structure and method of the present invention is described in further detail.

One embodiment of the improved data cache architecture is shown in FIG. 11, in the context of the multi-stage pipeline of the aforementioned ARC™ RISC processor. The architecture 1100 comprises a data cache 1102, bypass operand selection logic 1104 (decode stage), result selection logic 1106 (2 logic levels), latch control logic 1108 (2 levels), program counter (nextpc) address selection logic 1110 (2 levels), and cache address selection logic 1112 (2 levels), each of the logic units 1106, 1108, 1112 operatively supplying a third stage latch (register) 1116 disposed at the end of the second execution stage (E2) 1118. Summation logic 1111 is also provided which sums the outputs of the bypass operand selection logic 1104 prior to input to the multiplexers 1120, 1122 in the data cache 1102.

In addition to the multiplexers 1120, 1122, the data cache 1102 comprises a plurality of data random access memory (RAM) devices 1126 (0 through w-1), further having two sets of associated tag RAMs 1127 (0 through w-1) as shown. As used herein, the variable “w” represents the number of ways that a set associative cache may be searched. In general, w corresponds to the width of the memory array in multples of a word. For example, the memory may be two words wide (w=2) and the memory is then divided into two banks for access. The output of the data RAMs 1126 is multiplexed using a (w-1) channel multiplexer 1131 to the input of the byte/word/long word extraction logic 1132, the output of which is the load value 1134 provided to the result selection logic 1106. The output of each of the tag RAMs 1127 is logically ORed with the output of the summation logic 1111 in each of the 0 through w-1 memory units 1138. The outputs of the memory units 1138 are input in parallel to a logical “OR” function 1139 which determines the value of the load valid (ldvalid) signal 1140, the latter being input to the latch control logic 1108 prior to the third stage latch 1116.

In comparison to the prior art arrangement of FIG. 3 previously described, the present embodiment has relocated the bypass operand selection logic from the decode stage (and E2 stage) of the pipeline to the first execute stage (E1) as shown in FIG. 11. Additionally, the nextpc address selection logic 1110 receives the load value immediately after the data cache multiplexer 1131, as opposed to receiving the load value after the results selection logic as in FIG. 3. The valid signal for returning loads (1dvalid) 1140 is also routed directly to the two-level latch control logic 1108, versus to the pipeline control and hazard detection logic as in FIG. 3.

The foregoing modifications provide the following functionality:

(i) Assumption of data cache “hit” —In contrast to the prior art approach of FIGS. 3 and 3a, the ldvalid signal 1140 does not influence pipeline movement in the present invention, since it is decoupled from the control logic and hazard detection logic. Rather, it is assumed that the data cache will “hit”, and therefore the pipeline will continue to move. If this assumption is wrong, and the requested dataword is needed by an execution unit in the execution stage (E1 or E2), the pipeline is stalled at that point When the data cache 1102 makes the dataword available to the execution unit in need thereof, the operand for the instruction in the decode stage is updated.

(ii) Instruction Request Address Generation—Word or byte extracted load results do not usually generate the instruction request address for a jump register indirect instruction (e.g., j[rx]). Therefore, as part of the present invention, the instruction request address is generated earlier by the next address selection logic of FIG. 11, and a jump register indirect address where the register value is bypassed from a load byte or word causes a structural pipeline stall.

(iii) Relocation of Bypass Logic—As illustrated in FIG. 11, the present invention also relocates the bypass operand selection logic from stage 2 (decode) to stage 3 (execute E1), and from execute E2 to E1, to allow the multi-cycle/multi-stage functional units cache extra time on all cycles but the first.

FIG. 11a graphically illustrates the movement of the pipeline of an exeplary processor configured with the data cache integration improvements of the present invention. Note that the un-dashed bypass arrow 1170 indicates prior art bypass logic operation, while the dashed bypass arrow 1172 indicates bypass logic if it is moved from stage 2 to 3 according to the present invention. The following provides and explanation of the operation of the data cache of FIG. 11a.

In step 1174, a load (Ld) is requested. Next, a Mov is requested per step 1176. An Add is then requested per step 1178. In step 1180, the Ld begins to execute. In step 1182, the Mov begins to execute, and the cache misses. The Mov operation moves through the pipeline per step 1184. The Add operation stalls in execute stage E1, since the cache missed and the Add is dependent on the cache result. The cache then returns the Load Result Value per step 1186, and the Add is computed per step 1188. The Add moves through the pipeline per step 1190, the Add result is written back per step 1192.

As illustrated in FIG. 11a, the improved method of data cache integration of the present invention reduces the number of stalls encountered, as well as the impact of a cache “miss” (i.e., condition where the instruction is not cached in time) during the execution of the program. The present invention results in the add instruction continuing to move through the pipeline until reference ‘f’ saving instruction cycles. Further, by delaying pipeline stalls, the overall performance of the processor is increased.

Method of Enhancing Performance of Processor Design

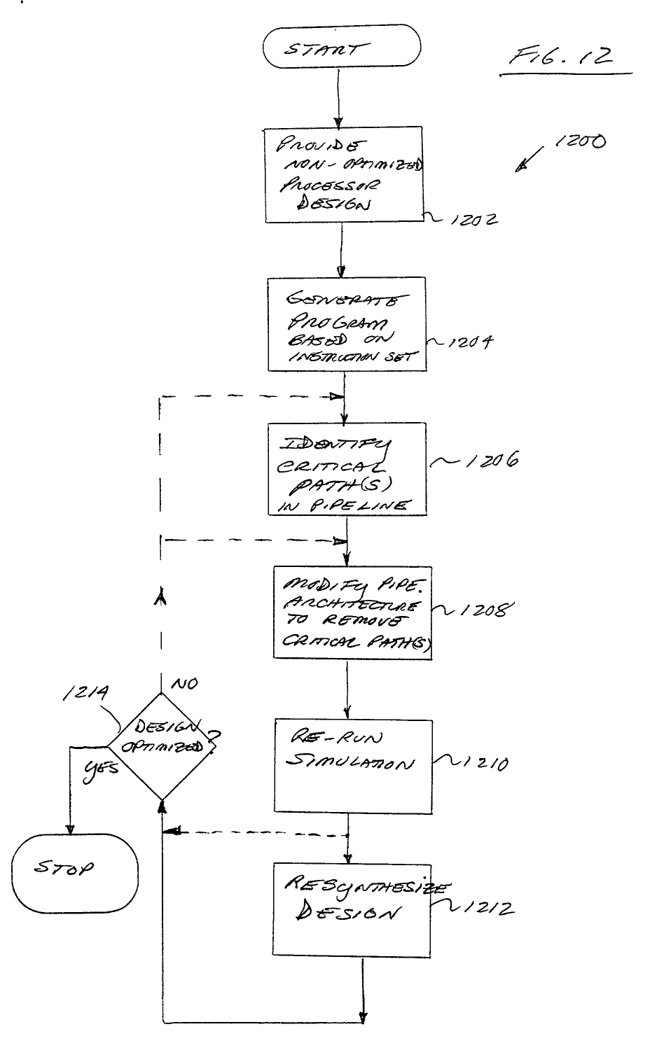

Referring now to FIG. 12, a method of enhancing the performance of a digital processor design such as the extensible ARC™ of the Assignee hereof is described. As illustrated in FIG. 12, the method generally comprises first providing a processor design which is non-optimized (step 1202), including inter alia critical path signals which unnecessarily delay the operation of the pipeline of the design. For example, the non-optimized prior art pipeline(s) of FIGS. 1 through 4a comprises such designs, although others may clearly be substituted. In the present embodiment of the method, the processor design further includes an instruction set having at least one breakpoint instruction, for reasons discussed in greater detail below.

Next, in step 1204, a program comprising a sequence of at least a portion of the processor's instruction set (including for example the aforementioned breakpoint instruction) is generated. The breakpoint instruction may be coded within a delay slot as previously described with respect to FIG. 8a herein, or otherwise.

Next, in step 1206, a critical path signal within the processing of program within the pipeline is identified. In the illustrated embodiment, the critical path is associated with the decode and processing of the breakpoint instruction. The critical path is identified through use of a simulation running a simulation program such as the “Viewsim™” program manufactured by Viewlogic Corporation, or other similar software. FIG. 4a illustrates the presence of a critical path signal in the dataword address (e.g., nextpc) generation logic of a typical processor pipeline.

Next, in step 1208 the architecture of the pipeline logic is modified to remove or mitigate the delay effects of the non-optimized pipeline logic architecture. In the illustrated embodiment, this modification comprises (i) relocating the instruction decode logic to the second (decode) stage of the pipeline as previously described with reference to FIG. 8, and (ii) including logic which resets the program counter (pc) to the breakpoint address, as previously described.

The simulation is next re-run (step 1210) with the modified pipeline configuration to verify the operability of the modified pipeline, and also determine the impact (if any) on pipeline operation speed. The design is then re-synthesized (step 1212) based on the foregoing pipeline modifications. The foregoing steps (i.e., steps 1206, 1208, 1210, and 1212, or subsets thereof) are optionally re-performed by the designer (step 1214) to further refine and improve the speed of the pipeline, or to optimize for other core parameters.

Method of Synthesizing

Referring now to FIG. 13, the method 1300 of synthesizing logic incorporating the long instruction word functionality previously discussed is described. The generalized method of synthesizing integrated circuit logic having a user-customized (i.e., “soft”) instruction set is disclosed in Applicant's co-pending U.S. Pat. application Ser. No. 09/418,663 entitled “Method And Apparatus For Managing The Configuration And Functionality Of A Semiconductor Design” filed Oct. 14, 1999, which is incorporated herein by reference in its entirety.

While the following description is presented in terms of an algorithm or computer program running on a microcomputer or other similar processing device, it can be appreciated that other hardware environments (including minicomputers, workstations, networked computers, “supercomputers”, and mainframes) may be used to practice the method. Additionally, one or more portions of the computer program may be embodied in hardware or firmware as opposed to software if desired, such alternate embodiments being well within the skill of the computer artisan.

Initially, user input is obtained regarding the design configuration in the first step 1302. Specifically, desired modules or functions for the design are selected by the user, and instructions relating to the design are added, subtracted, or generated as necessary. For example, in signal processing applications, it is often advantageous for CPUs to include a single “multiply and accumulate” (MAC) instruction. In the present invention, the instruction set of the synthesized design is further modified so as to incorporate the desired aspects of pipeline performance enhancement (e.g. “atomic” instruction word) therein.

The technology library location for each VHDL file is also defined by the user in step 1302. The technology library files in the present invention store all of the information related to cells necessary for the synthesis process, including for example logical function, input/output timing, and any associated constraints. In the present invention, each user can define his/her own library name and location(s), thereby adding further flexibility.

Next, in step 1303, the user creates customized HDL functional blocks based on the user's input and the existing library of functions specified in step 1302.

In step 1304, the design hierarchy is determined based on user input and the aforementioned library files. A hierarchy file, new library file, and makefile are subsequently generated based on the design hierarchy. The term “makefile” as used herein refers to the commonly used UNIX makefile function or similar function of a computer system well known to those of skill in the computer programming arts. The makefile function causes other programs or algorithms resident in the computer system to be executed in the specified order. In addition, it further specifies the names or locations of data files and other information necessary to the successful operation of the specified programs. It is noted, however, that the invention disclosed herein may utilize file structures other than the “makefile” type to produce the desired functionality.

In one embodiment of the makefile generation process of the present invention, the user is interactively asked via display prompts to input information relating to the desired design such as the type of “build” (e.g., overall device or system configuration), width of the external memory system data bus, different types of extensions, cache type/size, etc. Many other configurations and sources of input information may be used, however, consistent with the invention.

In step 1306, the user runs the makefile generated in step 1304 to create the structural HDL. This structural HDL ties the discrete functional block in the design together so as to make a complete design.

Next, in step 1308, the script generated in step 1306 is run to create a makefile for the simulator. The user also runs the script to generate a synthesis script in step 1308.

At this point in the program, a decision is made whether to synthesize or simulate the design (step 1310). If simulation is chosen, the user runs the simulation using the generated design and simulation makefile (and user program) in step 1312. Alternatively, if synthesis is chosen, the user runs the synthesis using the synthesis script(s) and generated design in step 1314. After completion of the synthesis/simulation scripts, the adequacy of the design is evaluated in step 1316. For example, a synthesis engine may create a specific physical layout of the design that meets the performance criteria of the overall design process yet does not meet the die size requirements. In this case, the designer will make changes to the control files, libraries, or other elements that can affect the die size. The resulting set of design information is then used to re-run the synthesis script.

If the generated design is acceptable, the design process is completed. If the design is not acceptable, the process steps beginning with step 1302 are re-performed until an acceptable design is achieved. In this fashion, the method 1300 is iterative.

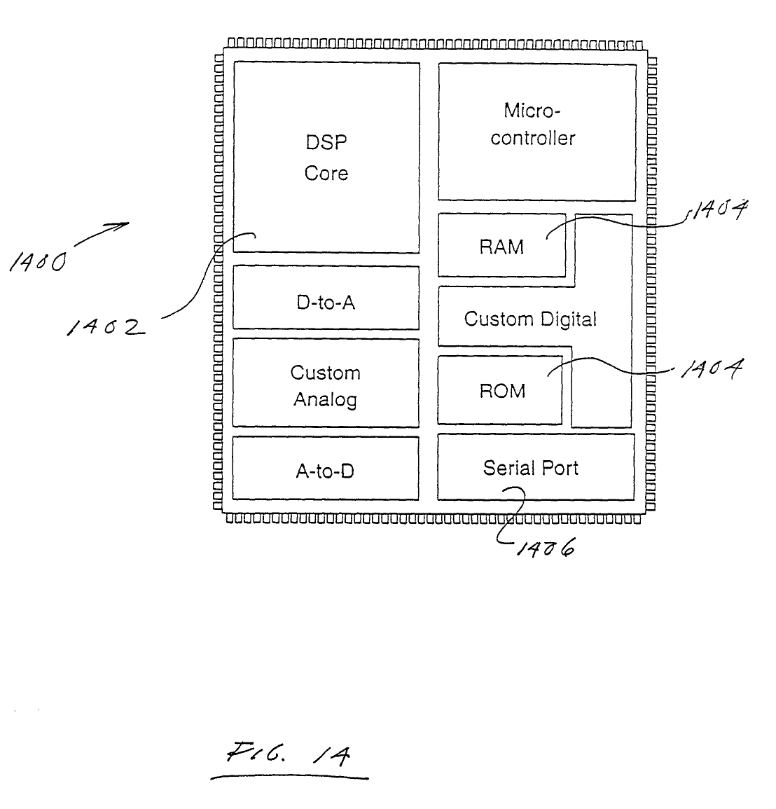

FIG. 14 illustrates an exemplary pipelined processor fabricated using a 1.0 um process. As shown in FIG. 14, the processor 1400 is an ARC™ microprocessor-like CPU device having, inter alia, a processor core 1402, on-chip memory 1404, and an external interface 1406. The device is fabricated using the customized VHDL design obtained using the method 1300 of the present invention, which is subsequently synthesized into a logic level representation, and then reduced to a physical device using compilation, layout and fabrication techniques well known in the semiconductor arts. For example, the present invention is compatible with 0.35, 0.18, and 0.1 micron processes, and ultimately may be applied to processes of even smaller or other resolution. An exemplary process for fabrication of the device is the 0.1 micron “Blue Logic” Cu-11 process offered by International Business Machines Corporation, although others may be used.

It will be appreciated by one skilled in the art that the processor of FIG. 14 may contain any commonly available peripheral such as serial communications devices, parallel ports, timers, counters, high current drivers, analog to digital (A/D) converters, digital to analog converters (D/A), interrupt processors, LCD drivers, memories and other similar devices. Further, the processor may also include custom or application specific circuitry, including an RF transceiver and modulator (e.g., Bluetooth™ compliant 2.4 GHz transceiver/modulator), such as to form a system on a chip (SoC) device useful for providing a number of different functionalities in a single package. The present invention is not limited to the type, number or complexity of peripherals and other circuitry that may be combined using the method and apparatus. Rather, any limitations are imposed by the physical capacity of the extant semiconductor processes which improve over time. Therefore it is anticipated that the complexity and degree of integration possible employing the present invention will further increase as semiconductor processes improve.

It is also noted that many IC designs currently use a microprocessor core and a DSP core. The DSP however, might only be required for a limited number of DSP functions, or for the IC's fast DMA architecture. The invention disclosed herein can support many DSP instruction functions, and its fast local RAM system gives immediate access to data. Appreciable cost savings may be realized by using the methods disclosed herein for both the CPU & DSP functions of the IC.

Additionally, it will be noted that the methodology (and associated computer program) as previously described herein can readily be adapted to newer manufacturing technologies, such as 0.18 or 0.1 micron processes (e.g. “Blue Logic™” Cu-11 process offered by IBM Corporation), with a comparatively simple re-synthesis instead of the lengthy and expensive process typically required to adapt such technologies using “hard” macro prior art systems.

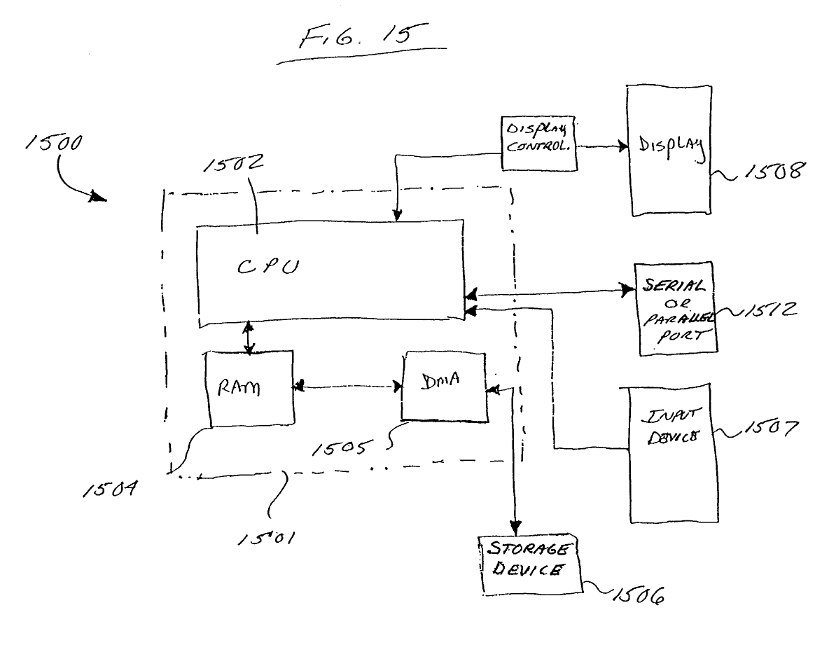

Referring now to FIG. 15, one embodiment of a computing device capable of synthesizing logic structures capable of implementing the pipeline performance enhancement methods discussed previously herein is described. The computing device 1500 comprises a motherboard 1501 having a central processing unit (CPU) 1502, random access memory (RAM) 1504, and memory controller 1505. A storage device 1506 (such as a hard disk drive or CD-ROM), input device 1507 (such as a keyboard or mouse), and display device 1508 (such as a CRT, plasma, or TFT display), as well as buses necessary to support the operation of the host and peripheral components, are also provided. The aforementioned VHDL descriptions and synthesis engine are stored in the form of an object code representation of a computer program in the RAM 1504 and/or storage device 1506 for use by the CPU 1502 during design synthesis, the latter being well known in the computing arts. The user (not shown) synthesizes logic designs by inputting design configuration specifications into the synthesis program via the program displays and the input device 1507 during system operation. Synthesized designs generated by the program are stored in the storage device 1506 for later retrieval, displayed on the graphic display device 1508, or output to an external device such as a printer, data storage unit, fabrication system, other peripheral component via a serial or parallel port 1512 if desired.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

We claim:

1. A method for avoiding the stalling of long immediate data instructions in a pipelined digital processor core having at least fetch, decode, and execution stages, comprising;
identifying, within said pipeline, at least one instruction containing long immediate values;
determining whether said at least one instruction has merged when said at least one instruction is in said decode stage of said pipeline; and
preventing said core from halting before said at least one instruction has merged.

2. The method of claim 1, wherein said act of determining comprises examining merge logic operatively coupled to said decode stage of said core to determine if a valid merge signal is present.

3. The method of claim 2, wherein said act of identifying at least one instruction comprises identifying an instruction selected from the group comprising (i) load immediate instructions, and (ii) jump instructions.

4. A digital processor core, comprising:
an instruction pipeline having a plurality of stages;
an instruction set having at least one instruction with multiple word long immediate values associated therewith;
core logic adapted to selectively treat said at least one instruction with said multi-word long immediate values as a single instruction word, said core logic preventing stalling of said core before processing of said at least one instruction has completed.

5. The core of claim 4, wherein said at least one instruction comprises an opcode and immediate data, said opcode and immediate data having at least one boundary there between, and said core is prevented from stalling on said at least one boundary.

6. The core of claim 5, wherein said instruction set further comprises a base instruction set and at least one extension instruction, said extension instruction being adapted to perform at least one function not defined within said base instruction set.

7. The core of claim 6, further comprising extension logic adapted to execute said at least one extension instruction.

8. A method of reducing pipeline delays within a pipelined processor, comprising:
providing a first instruction word;
providing a second instruction word; and
defining a single large instruction word comprising said first and second instruction words;
processing said single large word as a single instruction within said processor, thereby preventing stalling of the pipeline upon execution of said first and second instruction words.

9. The method of claim 8, wherein the acts of providing said first and second instruction words comprises providing an instruction having at least one long immediate value.

10. The method of claim 9, wherein the act of providing said instruction having said at least one long immediate value comprises providing an instruction opcode within said first instruction word, and said at least one long immediate value within said second instruction word.

11. The method of claim 9, wherein the act of processing comprises:
determining whether said first and second instruction words have merged within said pipeline; and
if said first and second words have not merged, preventing said pipeline from stalling on the boundary between said first and said instruction words.

12. A method of processing instruction words within a digital processor having an instruction set comprising a plurality of instruction words, a pipeline with at least first, second, and third pipeline stages, and a program counter adapted to identify at least one address in program memory space, comprising;
providing a program having a plurality of instruction words, including a first instruction word, in said program memory space, said first instruction word resulting in a stall of said pipeline when executed;
inserting said first instruction word into said first pipeline stage; and
delaying decode of said first word until said second stage.

13. The method of claim 12, wherein the act of inserting comprises inserting said first instruction into said pipeline between other instruction words, and the act of decoding comprises changing the program counter to the memory address value of said first instruction once said first instruction has been decoded in said second pipeline stage.

14. The method of claim 13, further comprising providing an extension instruction within said instruction set, said extension instruction adapted to perform a predetermined operation when executed on an extension logic unit of said processor.

15. The method of claim 14, wherein the act of providing an extension instruction comprises providing an instruction adapted for Viterbi decode.

16. The method of claim 12, wherein said act of inserting comprises disposing said first instruction within a delay slot within said pipeline.

17. A pipelined digital processor, comprising:
a pipeline having instruction fetch, decode, execute, and writeback stages;
a program memory adapted to store a plurality of instructions at addresses therein;
a program counter adapted to provide at least one value corresponding to a at least one of said addresses in said memory;
decode logic associated with said decode stage of said pipeline;
an instruction set comprising a plurality of instructions, said plurality further comprising at least one breakpoint instruction; and
a program comprising a predetermined sequence of at least a portion of said plurality of instructions, and including said at least one breakpoint instruction, said program being stored at least in part in said program memory;
wherein the decode of said at least one breakpoint instruction during execution of said program occurs after said instruction fetch stage using said decode logic, and said wherein said program counter is reset back to the memory address value associated with said breakpoint instruction after said breakpoint instruction is decoded.

18. The processor of claim 17, further comprising an extension logic unit adapted to execute one or more extension instructions.

19. The processor of claim 18, wherein said instruction set further comprises at least one extension instruction, said at least one extension instruction adapted to perform a predetermined function upon execution within said extension logic unit.

20. A method of debugging a digital processor having a multi-stage pipeline with fetch, decode, execute, and writeback stages, a program memory, a program counter adapted to provide at least one address within said memory, and an instruction set stored at least in part within said program memory, said instruction set including at least one breakpoint instruction, comprising;
providing a program comprising at least a portion of said instruction set and at least one breakpoint instruction;
running said program on said processor;
decoding said at least one breakpoint instruction during program execution at said decode stage of the pipeline;
executing the breakpoint instruction in order to halt operation of said processor;
resetting said program counter to the memory address value associated with said breakpoint instruction; and
debugging said processor at least in part while said processor is halted.

21. The method of claim 20, whereinsaid instruction set includes at least one extension instruction, said at least one extension instruction adapted to perform a predetermined function upon execution within said processor, said act of providing a program further comprises providing said at least one extension instruction therein, said method further comprising executing said at least one extension instruction during said dedubbing.

22. A method of enhancing the performance of a digital processor design, said processor design having a multi-stage instruction pipeline including at least instruction fetch, decode, and execution stages, an instruction set having at least one breakpoint instruction associated therewith, a program memory, and a program counter controlled at least in part by pipeline control logic, the method comprising:
providing a program comprising at least a portion of said instruction set, said at least portion including said breakpoint instruction;
simulating the operation of said processor using said program;
identifying a first critical path within the processing of said program based at least in part on said act of simulating, said critical path including the processing of said breakpoint instruction within said program; and
modifying said design to decode said breakpoint instruction within said decode stage of said pipeline so as to reduce processing delays associated with said first critical path.

23. The method of claim 22, wherein the act of modifying further comprises adapting said pipeline control logic so that said program counter resets to the memory address value associated with said breakpoint instruction after said breakpoint instruction is decoded within said decode stage.

24. A method of reducing pipeline delays within the pipeline of a digital processor, comprising:
providing a first register having a plurality of operating modes;
defining a bypass mode for said first register, wherein during operation in said bypass mode, said register maintains the result of a first multi-cycle operation therein;
performing a first multi-cycle operation to produce a first result;
storing said first result of said first operation in said first register using said bypass mode;
obtaining said first result of said first operation directly from said register;
and
performing a second multi-cycle operation using at least said first result of said first operation, said second operation producing a second result.

25. The method of claim 24, wherein said multi-cycle operation comprises an iterative scalar calculation, said method further comprising performing the acts of storing, obtaining, and performing for said second result of said second operation, and a plurality of subsequent results from respective subsequent operations, wherein the result of a given operation is stored in said first register using said bypass mode, and subsequently obtained from said register for use in the next subsequent iteration of said calculation.

26. A processor core, comprising:
a multi-stage instruction pipeline having at least fetch, decode, and execute stages;
an instruction set having at least one multi-cycle instruction and at least one other instruction subsequent thereto; and
a first register disposed within the execute stage of said pipeline, said first register having a bypass mode associated therewith, said bypass mode adapted to:
(i) retain at least a portion of the result of the execution of said at least one multi-cycle instruction within said execute stage; and
(ii) present said result to said at least one other instruction for use thereby.

27. The processor core of claim 26, wherein said first register is further adapted to latch source operands to permit fully static operation.

28. The processor core of claim 26, wherein said at least one multi-cycle instruction comprises two sequential data words, the first of said data words comprising at least opcode, and the second of said data words comprising at least one operand.

29. The processor core of claim 28, further comprising core logic adapted to selectively treat said at least one multi-cycle instruction with said data words as a single instruction word, said core logic preventing stalling of said core before processing of said at least one instruction has completed.

30. The processor core of claim 28, wherein said instruction set further comprises at least one extension instruction, said at least one extension instruction being adapted to perform a predetermined function upon execution thereof by said core.

31. The processor core of claim 30, further comprising an extension logic unit adapted to execute said at least one extension instruction.

32. A method of operating a data cache within a pipelined processor, said pipeline comprising a plurality of stages including at least decode and execute stages, at least one execution unit within said execute stage, and pipeline control logic, said method comprising:
providing a plurality of instruction words;
introducing said plurality of instruction words within said stages of said pipeline successively;
allowing said instruction words to advance one stage ahead of the data word within said data cache;
examining the status of said data cache; and
stalling said pipeline using said control logic only when a data word required by said at least one execution unit is not present within said data cache.

33. The method of claim 32, further comprising:
making said data word available to said execution unit; and
updating the operand for the instruction in the stage prior to said execute stage.

34. The method of claim 33, wherein the act of updating comprises updating the operand in the decode stage of said pipeline.

35. A pipelined digital processor, comprising:
a pipeline having instruction fetch, decode, execute, and writeback stages;
storage means adapted for storing a plurality of instructions at addresses therein;
address generation means for providing at least one value corresponding to a at least one of said addresses in said storage;
means for decoding an instruction word, said means for decoding associated with said decode stage of said pipeline;
an instruction set comprising a plurality of instructions, said plurality further comprising at least one instruction means for halting operation of said processor pipeline; and
a program comprising a predetermined sequence of at least a portion of said plurality of instructions, and including said at least one instruction means for halting, said program being stored at least in part in said storage means;
wherein the decode of said at least one instruction means during execution of said program occurs after said instruction fetch stage using said means for decoding, and said wherein said address generation means is reset back to the address value associated with said instruction means after said instruction means is decoded.

36. A processor core, comprising:
a multi-stage instruction pipeline having at least fetch, decode, and execute stages;
an instruction set having at least one multi-cycle instruction means and at least one other instruction subsequent thereto; and
means or storing disposed within the execute stage of said pipeline, said means for storing having a bypass means associated therewith, said bypass means adapted to perform the steps comprising:
(i) retaining at least a portion of the result of the execution of said at least one multi-cycle instruction means within said execute stage; and
(ii) presenting said result to said at least one other instruction for use thereby.

37. The procesor core of claim 36, wherein steps (i) and (ii) are performed repetitively by said means for storing and said bypass means.

38. A method of synthesizing the design of an integrated circuit, said design including a pipelined processor having optimized pipeline performance:
providing input regarding the configuration of said design, said configuration including at least one optimized pipeline architectural function;
providing at least one library of functions, said at least one library comprising descriptions of functions including that of said at least one pipeline architectural function;
creating a functional description of said design based on said input and said at least one library of functions;
determining a design hierarchy based on said input and at least one library;
generating structural HDL and a script associated therewith;
running said script to create a synthesis script; and
synthesizing said design using synthesis script.

39. The method of claim 38, wherein the act of providing input regarding the said at least one optimized pipeline architectural function comprises:
describing at least one multi-word instruction comprising a first opcode word and a second data word; and
specifying that said instruction is non-stallable on the boundary between said first and second words during execution thereof.

40. The method of claim 38, wherein the act of providing input regarding the said at least one optimized pipeline architectural function comprises:
describing a multi-function register disposed within said pipeline, said register adapted to store the results of the execution of a multi-cycle instruction word within the execute stage of said pipeline; and
specifying that sid result be provided to at least one instruction subsequent to said multi-cycle instruction within said pipleine during operation.

41. The method of claim 38, wherein the act of providing input regarding the said at least one optimized pipeline architectural function comprises:
describing pipeline control logic adapted to control the operation of said pipeline;
describing at least one execution unit within the execution stage of said pipeline; describing at least one data cache structure within said design;
specifying that said pipeline control logic be at least partly decoupled from said data cache, thereby allowing the processing of a given instruction within said pipeline to proceed ahead of said data cache; and
further specifying that said pipeline control logic halt said pipeline if a data word required by said at least one execution unit is not present within said data cache.
